(19) United States
(12) Patent Application Publication
(10) Pub. No.: US 2010/0185308 A1
(43) Pub. Date: Jul. 22, 2010

(54) Sound Signal Processing Device And Playback Device

(75) Inventors: Masahiro YOSHIDA, Osaka (JP); Tomoki OKU, Osaka (JP); Makoto YAMANAKA, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/688,344

(22) Filed: Jan. 15, 2010

(30) Foreign Application Priority Data
Jan. 16, 2009 (JP) 2009007172
Nov. 20, 2009 (JP) 2009264565

(51) Int. Cl. G06F 17/00; H04B 1/00

(52) U.S. Cl. 700/94; 381/119

(57) ABSTRACT

A sound signal processing device has a signal outputter which outputs a target sound signal obtained by collecting sounds from a plurality of sound sources, and a sound volume controller which adjusts the sound volumes of the individual sound sources in the target sound signals according to the directions or locations of the sound sources and according to the types of the sound sources.

This nonprovisional application claims priority under 35 U.S.C. §119(a) on Patent Application No. 2009-007172 filed in Japan on Jan. 16, 2009 and Patent Application No. 2009-264565 filed in Japan on Nov. 20, 2009, the entire contents of which are hereby incorporated by reference.

### BACKGROUND OF THE INVENTION

1. Field of the Invention

The present invention relates to a sound signal processing device that processes a sound signal, and to a playback device that plays back from a sound signal. The present invention also relates to a recording device, a playback device, an image shooting device, etc. that employ such a sound signal processing device.

2. Description of Related Art

Many recording devices (such as IC recorders) and image shooting devices (such as digital video cameras) that can record a sound signal adopt control for correcting the level of a sound signal to be recorded in such a way as to keep its signal level largely constant. Such control is generally called automatic gain control (hereinafter called AGC) or automatic level control (hereinafter called ALC).

In AGC or ALC, an input sound signal is amplified to generate an output sound signal, and the voltage amplitude of the output sound signal is so controlled as to be substantially constant. In a case where the voltage amplitude of the input sound signal varies as shown in FIG. 20, the amount of amplification (amplification factor) with respect to the input sound signal is varied gradually in such a way that the voltage amplitude of the output sound signal tends to return to the constant amplitude. Such control in AGC or ALC is executed in the time domain.

According to one conventionally disclosed method using AGC or ALC (hereinafter called the first conventional method), based on the largest output value of a front-direction and a rear-direction sound signal, the balance between the sound volumes of the front-direction and rear-direction sound signals is controlled.

According to one well-known method (hereinafter called the second conventional method), sound volume is controlled separately in each of discrete frequency bands so that the overall sound volume may not be affected by an extremely loud sound of specific frequencies, such as of fireworks.

These conventional methods, however, have the following disadvantages. With the first conventional method, even in a case where the front-direction sound signal conveys a necessary sound such as a human voice and the rear-direction sound signal conveys an unnecessary sound such as noise, the sound volumes of the two signals are adjusted on the same scale, possibly making the necessary sound difficult to hear.

With the second conventional method, the signal component of specific frequencies corresponding to an unnecessary sound (such as of fireworks) can be reduced but, in a case where the frequencies of the unnecessary and a necessary sound overlap, even, the signal component of the necessary sound is reduced.

A capability of adjusting the sound volume of a sound source considered to be necessary and the sound volume of a sound source considered to be unnecessary each properly would greatly benefit the user.

When the trouble of operation on the user's part and the like are taken into account, automatic adjustment of sound volume by a sound signal processing device provided in a recording, playback, or other device does have advantages. Inconveniently, however, what kind of sound originating from what direction is necessary or unnecessary changes according to what the user desires in different cases. It is therefore of significance to meet such user requirements, and for that purpose it is important to present the user with information assisting in his decision between necessity and unnecessity.

On the other hand, the user often desires to hear the sound of a particular sound source in a form extracted from, or emphasized in, a recorded sound signal. For example, in a case where the sounds at a children's theatrical event or the like are recorded, while the voices of many people, music, etc. are recorded, the user may want to play back only the voice of a particular person (such as the recorder operator's child) walking around on the stage, in a form extracted from the recorded sound signal. In this case, directivity may be controlled with respect to the recorded sound signal so that only sounds from a particular direction may be played back in an extracted form. If, however, that particular person, as a sound source, moves around as he likes (or even when this person stays motionless, if the recording device moves during recording), the voice of the particular person goes out of the specified direction during playback of the directivity-controlled recorded sound signal and is thus excluded from the playback sound. A technology to avoid such situations has therefore been expected to be developed.

### SUMMARY OF THE INVENTION

According to the invention, a sound signal processing device is provided with: a signal outputter which outputs a target sound signal obtained by collecting sounds from a plurality of sound sources; and a sound volume controller which adjusts the sound volumes of the individual sound sources in the target sound signal according to the directions or locations of the sound sources and according to the types of the sound sources.

Specifically, for example, the plurality of sound sources include first to n-th sound sources (where n is an integer of 2 or more), and the target sound signal includes first to n-th unit sound signals corresponding to the first to n-th sound sources and separated from one another; the first to n-th unit sound signals are extracted from the detection signals of a plurality of microphones arranged at different positions, or are obtained by collecting the sounds from the first to n-th sound sources individually.

That is, for example, the first to n-th unit sound signals are extracted from the detection signals of the plurality of microphones; the signal outputter generates, from the detection signals of the plurality of microphones, and outputs, as the first to n-th unit sound signals, n sound signals having directivity in which the signal components of sounds originating from first to n-th directions are emphasized; and the sound volume controller adjusts the sound volumes of the individual sound sources in the target sound signal according to the first to n-th directions representing the directions of the first to n-th sound sources and according to the types of the sound sources.

Or, for example, the first to n-th unit sound signals are obtained by collecting the sounds from the first to n-th sound sources individually, and the directions or locations of the sound sources are determined from the directivity or arrangement positions of individual microphones for collecting the sounds from the first to n-th sound sources individually.

Specifically, for example, there are additionally provided: a sound type detector which discriminates the types of the sound sources of the individual unit sound signals based on the unit sound signals; and a sound volume detector which detects the signal levels of the individual unit sound signals. Here, the sound volume controller adjusts the sound volumes of the individual sound sources in the target sound signal by adjusting the signal levels of the unit sound signals individually based on the directions or locations of the sound sources, based on the types of the sound sources discriminated by the sound type detector, and based on the signal levels detected by the sound volume detector.

For example, in the sound volume controller, the band of each unit sound signal is divided into a plurality of sub-bands, and the signal level of each unit sound signal is adjusted in each sub-band individually.

For example, an appliance is provided with the sound signal processing device described above, the appliance recording or playing back, as an output sound signal, the target sound signal as having undergone the volume adjustment by the sound volume controller of the sound signal processing device, or a sound signal based on the target sound signal as having undergone the volume adjustment.

For example, the above appliance includes a recording device which records the output sound signal, a playback device which plays back the output sound signal, or an image shooting device which records or plays back the output sound signal along with the image signal of a shot image.

According to the invention, a playback device which plays back, as sounds, an output sound signal based on an input sound signal obtained by collecting sounds from a plurality of sound sources is provided with: a sound characteristics analyzer which analyzes the input sound signal for each sound origination direction to generate characteristics information representing sound characteristics for each sound origination direction; a notifier which indicates the characteristics information to outside the playback device; an operation receiver which receives, from outside, input operation including direction specification operation for specifying one or more of first to m-th different origination directions (where m is an integer of 2 or more) present as sound origination directions; and a signal processor which generates the output sound signal by applying signal processing according to the input operation to the input sound signal.

Specifically, for example, the signal processor generates the output sound signal by extracting, from the input sound signal, signal components from the one or more origination directions specified by the input operation, or generates the output sound signal by applying, to the input sound signal, signal processing for emphasizing or attenuating signal components from the one or more origination directions specified by the input operation, or generates the output sound signal by mixing, according to the input operation, signal components from the individual origination directions included in the input sound signal.

According to the invention, another playback device which plays back, as sounds, an output sound signal based on an input sound signal obtained by collecting sounds from a plurality of sound sources is provided with: a sound characteristics analyzer which analyzes the input sound signal for each sound origination direction to generate characteristics information representing sound characteristics for each sound origination direction; and a signal processor which selects one or more of first to m-th different origination directions (where m is an integer of 2 or more) present as sound origination directions and which generates the output sound signal by applying, to the input sound signal, signal processing for extracting, from the input sound signal, signal components from the selected one or more origination directions or signal processing for emphasizing signal components from the selected one or more origination directions. Here, the signal processor switches the selected one or more origination directions according to the characteristics information.

Specifically, for example, the entire span of the input sound signal includes first and second different spans, and the signal processor determines the selected one or more origination directions based on the characteristics information of the input sound signal such that the origination direction of the signal component of a sound having particular characteristics is included in the selected one or more origination directions in both the first and second spans.

According to the invention, yet another a playback device which generates an output sound signal from an input sound signal including a plurality of unit sound signals obtained by collecting sounds from a plurality of sound sources individually and which plays back the output sound signal as sounds is provided with: a sound characteristics analyzer which analyzes the unit sound signals to generate, for each unit sound signal, characteristics information representing characteristics of a sound; a notifier which indicates the characteristics information to outside the playback device; an operation receiver which receives, from outside, input operation including specification operation for specifying one or more of the plurality of unit sound signals (where m is an integer of 2 or more); and a signal processor which generates the output sound signal by applying signal processing according to the input operation to the input sound signal.

Specifically, for example, the signal processor generates the output sound signal by extracting, from the input sound signal, the one or more unit sound signals specified by the input operation, or generates the output sound signal by applying, to the input sound signal, signal processing for emphasizing or attenuating the one or more unit sound signals specified by the input operation, or generates the output sound signal by mixing, according to the input operation, signal components from the individual unit sound signals included in the input sound signal.

For example, in any of the playback devices described above, the characteristics information for each sound origination direction or for each unit sound signal includes at least one of sound volume information representing the sound volume of a sound, sound type information representing the sound type of a sound, human voice presence/absence information representing whether or not a sound contains a human voice, and talker information representing the talker when a sound is a human voice.

The significance and benefits of the invention will be clear from the following description of its embodiments. It should however be understood that these embodiments are merely examples of how the invention is implemented, and that the meanings of the terms used to describe the invention and its features are not limited to the specific ones in which they are used in the description of the embodiments.

### BRIEF DESCRIPTION OF THE DRAWINGS

FIG. 1 is a diagram showing a positional relationship of two microphones according to Embodiment 1 of the invention;

FIG. 2 is a diagram showing how space is divided into six areas in relation to two microphones;

FIG. 3 is an internal block diagram of a sound signal processing device according to Embodiment 1 of the invention;

FIG. 4 is an example of an internal block diagram of the sound source separator in FIG. 3;

FIG. 5 is a diagram showing an example of arrangement of sound sources;

FIG. 6 is a diagram showing how a digital sound signal is divided into units called frames;

FIG. 7 is a diagram showing an example of the frequency spectrum of a sound signal conveying a human voice;

FIG. 8 is a diagram showing an example of the frequency spectrum obtained by discrete Fourier transform;

FIG. 9 is a diagram showing how a reference block and an evaluation block are set with respect to a digital sound signal in the time domain;

FIG. 10 is a diagram showing a self-correlation value that periodically exceeds a predetermined threshold value;

FIG. 11 is a diagram showing temporal variation of the frequency spectrum of noise;

FIG. 12 is a diagram showing how the band of a sound signal is divided into eight sub-bands;

FIGS. 13A to 13C are diagrams illustrating the processing by the volume control amount setter in FIG. 3 for setting an upper-limit amount of amplification;

FIG. 14 is a diagram showing a plurality of sound sources located at discrete locations in space;

FIG. 15 is a flow chart of a procedure for calculating an amount of amplification with respect to a front sound signal;

FIG. 16 is a flow chart of a procedure for calculating an amount of amplification with respect to a non-front sound signal;

FIG. 17 is a schematic block diagram of a recording device according to Embodiment 1 of the invention;

FIG. 18 is a schematic block diagram of a sound signal playback device according to Embodiment 1 of the invention;

FIG. 19 is a schematic block diagram of an image shooting device according to Embodiment 1 of the invention;

FIG. 20 is a diagram showing processing for automatic gain control or automatic level control according to a conventional technology;

FIG. 21 is a schematic block diagram of a recording/playback device according to Embodiment 4 of the invention;

FIG. 22 is a part block diagram of a recording/playback device, including an internal block diagram of a sound signal processing device, according to Embodiment 4 of the invention;

FIG. 23 is an internal block diagram of the signal separator in FIG. 22;

FIG. 24 is a diagram illustrating a plurality of areas etc. defined in Embodiment 4 of the invention;

FIG. 25 is a diagram illustrating a plurality of areas etc. defined in Embodiment 4 of the invention;

FIG. 26 is a diagram showing the structure of characteristics information according to Embodiment 4 of the invention;

FIG. 27 is a diagram showing an image displayed on a display section according to Embodiment 4 of the invention;

FIGS. 28A to 28C are diagrams showing sound source icons displayed on a display section according to Embodiment 4 of the invention;

FIGS. 29A and 29B are diagrams showing a first and a second example, respectively, of display images according to Embodiment 4 of the invention;

FIGS. 30A to 30C are diagrams illustrating the significance of an entire span, a particular span, a first span, and a second span according to Embodiment 4 of the invention;

FIG. 31 is a diagram showing a sound signal icon corresponding to a talking person lit according to Embodiment 4 of the invention;

FIG. 32 is a diagram showing another image displayed on a display section according to Embodiment 4 of the invention;

FIG. 33 is a conceptual diagram of processing for compositing a plurality of sound signals;

FIGS. 34A and 34B are diagrams illustrating operation for increasing or reducing the sound volume of a sound signal in a desired direction according to Embodiment 4 of the invention;

FIGS. 35A to 35C are diagrams illustrating operation for enlarging a particular area according to Embodiment 4 of the invention;

FIG. 36 is an operation flow chart of a recording/playback device in which a sound source tracking function is realized according to Embodiment 4 of the invention;

FIGS. 37A and 37B are diagrams illustrating processing for a sound source tracking function according to Embodiment 4 of the invention;

FIGS. 38A and 38B are diagrams illustrating applied techniques applicable to Embodiment 4 of the invention;

FIG. 39 is a part block diagram of a recording/playback device, including an internal block diagram of a sound signal processing device, according to Embodiment 5 of the invention; and

FIG. 40 is a diagram showing an image displayed on a display section according to Embodiment 5 of the invention.

### DETAILED DESCRIPTION OF PREFERRED EMBODIMENTS

Hereinafter, several embodiments of the present invention will be described specifically with reference to the accompanying drawings. Among the drawings referred to in the course of description, the same parts are identified by the same reference signs, and in principle no overlapping description of the same parts will be repeated. Embodiment 1 is an embodiment that provides the basis for other embodiments, and unless inconsistent, any feature described with regard to Embodiment 1 applies to any other embodiment. Also, unless inconsistent, any feature described with regard to one embodiment may be implemented in combination with any feature described with regard to another embodiment.

### Embodiment 1

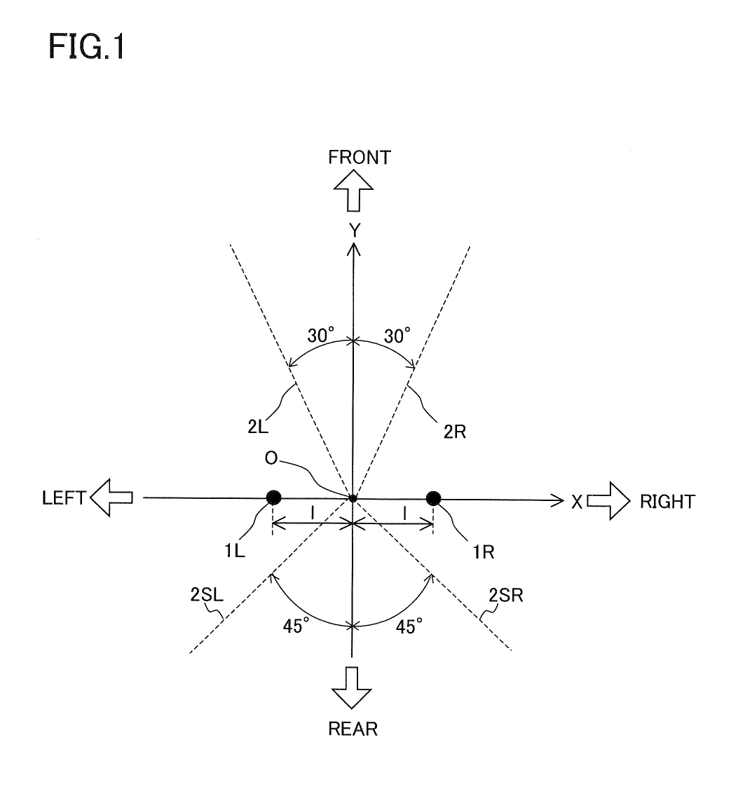

A first embodiment (Embodiment 1) of the invention will now be described. First, with reference to FIG. 1, a description will be given of the positional relationship of microphones 1L and 1R usable in the sound signal processing device described later.

Consider now a two-dimensional coordinate plane having mutually perpendicular X and Y axes as coordinate axes. X and Y axes intersect perpendicularly at origin O. With respect to origin O, the positive direction of X axis will be referred to as rightward, the negative direction of X axis as leftward, the positive direction of Y axis as frontward, and the negative direction of Y axis as rearward. The positive direction of Y axis is the direction in which a main sound source is supposed to be located.

Microphones 1L and 1R are arranged at different positions on X axis. The microphone 1L is arranged at a distance 1 (the symbol is the lower-case “L”) leftward from origin O, and the microphone 1R is arranged at a distance 1 rightward from origin O. The distance 1 is, for example, several cm (centimeters). Four line segments extending from origin O into the first, second, third, and fourth quadrants on the XY coordinate plane will be referred to as line segments 2R, 2L, 2SL, and 2SR respectively. Line segment 2R is inclined 30 degrees clockwise relative to Y axis, and line segment 2L is inclined 30 degrees counter-clockwise relative to Y axis. Line segment 2SR is inclined 45 degrees counter-clockwise relative to Y axis, and line segment 2SL is inclined 45 degrees clockwise relative to Y axis.

Consider now that, with X and Y axes and line segments 2R, 2L, 2SL, and 2SR as borders, the XY coordinate plane divides into six areas 3C, 3L, 3SL, 3B, 3SR, and 3R. Area 3C is a part, lying between line segments 2R and 2L, of the first and second quadrants on the XY coordinate plane. Area 3L is a part, lying between line segment 2L and X axis, of the second quadrant on the XY coordinate plane. Area 3SL is a part, lying between X axis and line segment 2SL, of the third quadrant on the XY coordinate plane. Area 3B is a part, lying between line segments 2SL and 2SR, of the third and fourth quadrants on the XY coordinate plane. Area 3SR is a part, lying between line segment 2SR and X axis, of the fourth quadrant on the XY coordinate plane. Area 3R is a part, lying between X axis and line segment 2R, of the first quadrant on the XY coordinate plane.

The microphone 1L collects sound, converts it into an electric signal, and outputs a detection signal representing the sound. The microphone 1R collects sound, converts it into an electric signal, and outputs a detection signal representing the sound. These detection signals are analog sound signals. The analog sound signals, that is, the detection signals of the microphones 1L and 1R, are converted into digital sound signals respectively by an unillustrated A/D (analog-to-digital) converter. It is assumed that the sampling frequency at which the A/D converter converts the analog to the digital sound signals is 48 kHz (kilohertz). Usable as the microphones 1L and 1R are non-directional microphones, that is, microphones having no directivity.

Consider that the microphone 1L corresponds to the left channel, and that the microphone 1R corresponds to the right channel. The digital sound signals obtained through digital conversion of the detection signals of the microphones 1L and 1R are called the original signals L and R respectively. The original signals L and R are signals in the time domain.

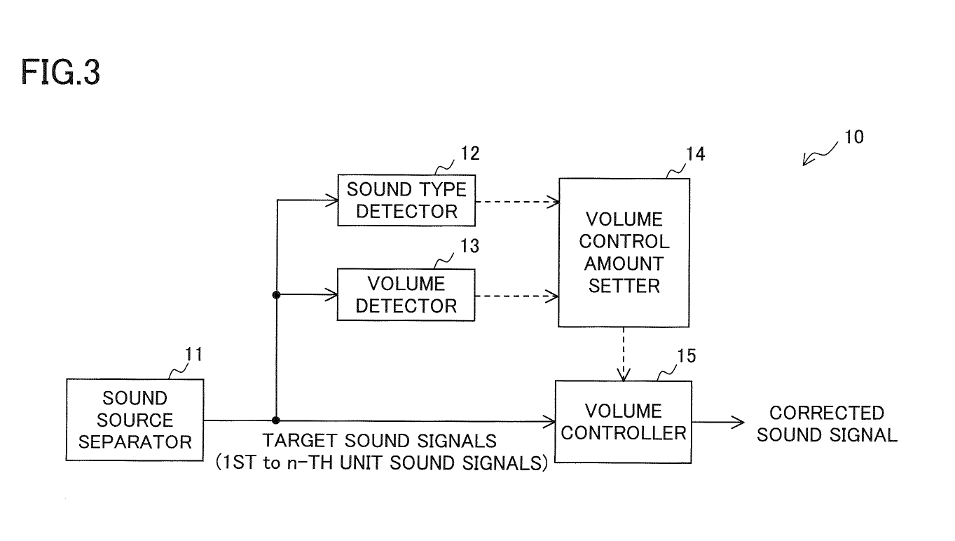

FIG. 3 shows an internal block diagram of a sound signal processing device 10 according to Embodiment 1. The sound signal processing device 10 is provided with the following blocks: a sound source separator 11 which generates and outputs sound signals that are obtained by collecting the sounds from a plurality of sound sources located at discrete positions in space and separating and extracting, one from the others, the signals from the individual sound sources; a sound type detector 12 which detects the types of the individual sound sources based on the sound signals from the sound source separator 11; a volume detector 13 which detects the sound volumes of the individual sound sources based on the sound signals from the sound source separator 11; a volume control amount setter 14 which decides the amounts of amplification with respect to the sound volumes of the individual sound sources based on the results of detection by the sound type detector 12 and the volume detector 13; and a volume controller 15 which, based on the result of decision by the volume control amount setter 14, adjusts the levels of the signals of the individual sound sources contained in the output sound signals of the sound source separator 11 and thereby adjusts the sound volumes of the individual sound sources.

As described above, the sound signals outputted from the sound source separator 11 have been corrected through signal level adjustment by the volume controller 15. Accordingly, for the sake of convenience, the sound signals outputted from the sound source separator 11 will be called the target sound signals, and the output sound signals of the volume controller 15 which are obtained by subjecting the target sound signals to that signal level adjustment will be called the corrected sound signals.

The target sound signals are sound signals including a first unit sound signal representing the sound from the first sound source, a second unit sound signal representing the sound from the second sound source, . . . , a (n−1)-th unit sound signal representing the sound from the (n−1)-th sound source, and an n-th unit sound signal representing the sound from the n-th sound source. Here, n is an integer of 2 or more. It is here assumed that the first to n-th sound sources are located at discrete positions on the XY coordinate plane, which is taken as representing real space.

### Sound Source Separator

The sound source separator 11 generates and outputs unit sound signals one for each of the sound sources. For example the sound source separator 11 can generate each unit sound signal by emphasizing, through directivity control, the signal component of a sound originating from a particular direction based on the detection signals of a plurality of microphones. Various methods for directivity control have been proposed, and the sound source separator 11 may adopt any directivity control method including those well known (for example, the methods disclosed in JP-A-2000-81900 and JP-A-H10-313497) to generate each unit sound signal.

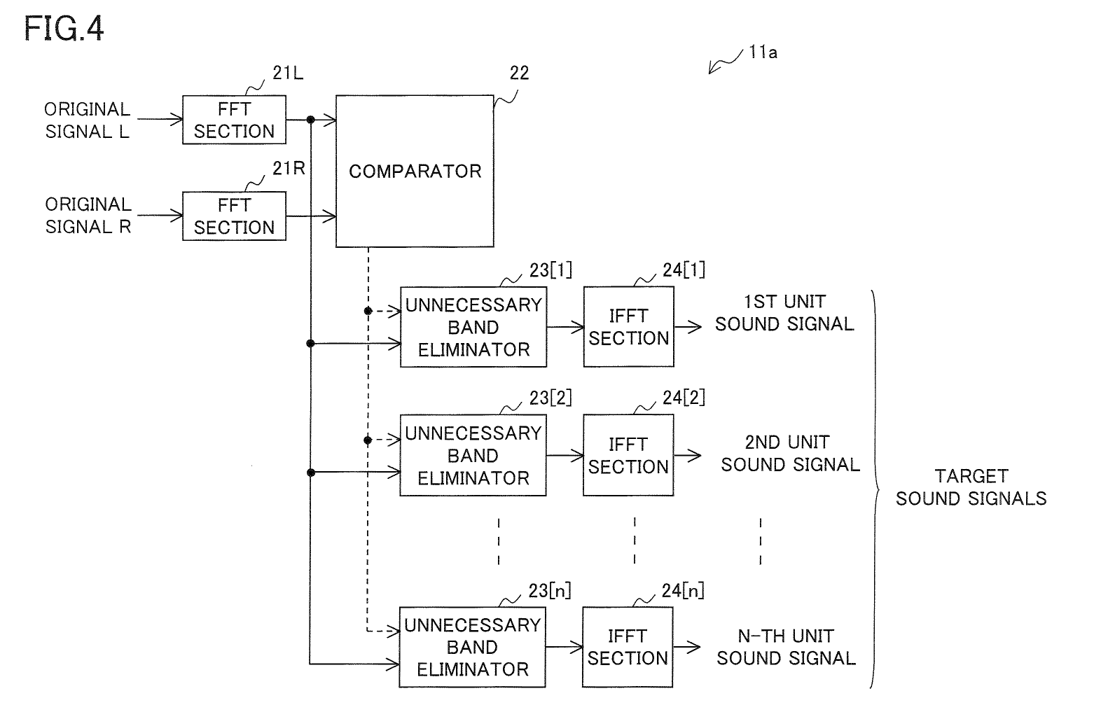

As a more specific example, a method for generating each unit sound signal from the original signals L and R, that is, the detection signals of the microphones 1L and 1R, will be described. FIG. 4 is an internal block diagram of a sound source separator 11a usable as the sound source separator 11 in FIG. 3. The sound source separator 11a is provided with FFT sections 21L and 21R, a comparator 22, unnecessary band eliminators 23[1] to 23[n], and IFFT sections 24[1] to 24[n].

The FFT sections 21L and 21R perform discrete Fourier transform on the original signals L and R, which are signals in the time domain, and thereby calculates left- and right-channel frequency spectra, which are signals in the frequency domain. Through discrete Fourier transform, the frequency bands of the original signals L and R are divided into a plurality of frequency bands, and the frequency sampling intervals in the discrete Fourier transform by the FFT sections 21L and 21R are so set that each of the thus divided frequency bands only contains the sound signal component from one sound source. This setting makes it possible to separate and extract, from signals containing the sound signals of a plurality of sound sources, the sound signal component of each sound source. In the following description, the divided frequency bands will be called the divided bands.

Based on data representing the result of the discrete Fourier transform by the FFT sections 21L and 21R, the comparator 22 calculates, for each divided band, the phases of the left- and right-channel signal components in that divided band. With each divided band taken as of interest separately, based on the phase difference between the left and right channels in the divided band of interest, a judgment is made of from what direction the main component of the signal in that divided band originated. This judgment is made for all the divided bands, and the divided band that has been judged to be one in which the main component of the signal originated from an i-th direction is set as an i-th necessary band. In a case where there are a plurality of divided bands that have been judged to be ones in which the main component of the signal originated from an i-th direction, a composite band of those divided bands together is set as an i-th necessary band. This setting processing is executed for each of i=1, 2, . . . , (n−1), and n, with the result that a first to an n-th necessary band are set which correspond to a first to n-th direction.

The unnecessary band eliminator 23[1] takes any divided band not belonging to the first necessary band as an unnecessary band, and reduces, by a predetermined amount, the signal level in the unnecessary band within the frequency spectrum calculated by the FFT section 21L. For example, through the reduction here, the signal level in the unnecessary band is reduced by 12 dB (decibels) in terms of voltage ratio. The unnecessary band eliminator 23[1] does not reduce the signal level in the first necessary band. The IFFT section 24[1], by use of inverted discrete Fourier transform, converts the frequency spectrum after signal level reduction by the unnecessary band eliminator 23[1] into a signal in the time domain, and outputs the signal resulting from this conversion as a first unit sound signal. It should be understood that a signal level denotes the power of a signal of interest. It is however also possible to understand a signal level as the amplitude of a signal of interest.

The unnecessary band eliminators 23[2] to 23[n] and the IFFT sections 24[2] to 24[n] operate in a similar manner. Specifically, for example, the unnecessary band eliminator 23 [2] takes any divided band not belonging to the second necessary band as an unnecessary band, and reduces, by a predetermined amount, the signal level in the unnecessary band within the frequency spectrum calculated by the FFT section 21L. For example, through the reduction here, the signal level in the unnecessary band is reduced by 12 dB (decibels) in terms of voltage ratio. The unnecessary band eliminator 23[2] does not reduce the signal level in the second necessary band. The IFFT section 24[2], by use of inverted discrete Fourier transform, converts the frequency spectrum after signal level reduction by the unnecessary band eliminator 23 [2] into a signal in the time domain, and outputs the signal resulting from this conversion as a second unit sound signal.

The i-th unit sound signal thus obtained is a sound signal representing only the sound from the i-th sound source as collected by the microphone section (here, errors etc. are ignored). The symbol i represents one of 1, 2, . . . , (n−1), and n. In the example under discussion, the microphone section comprises the microphones 1L and 1R. The first to n-th unit sound signals are, as the sound signals of the first to n-th sound sources, outputted from the sound source separator 11a.

Any direction mentioned as an i-th direction (the direction of an i-th sound source), and any direction mentioned in connection with such a direction, is a direction with respect to origin O (see FIG. 1). The first to n-th directions are all directions pointing from the respective sound sources of interest to origin O, and the first to n-th directions are different from one another. For example, in a case where, as shown in FIG. 5, a sound source 4C as a first sound source is located in area 3C and a sound source 4L as a second sound source is located in area 3L, the direction pointing from the sound source 4C to origin O is the first direction, and the direction pointing from the sound source 4L to origin O is the second direction; the sound source separator 11a extracts the sound signals representing the sounds from the sound sources 4C and 4L separately as the first and second unit sound signals. An i-th direction may be understood as a direction allowing some breadth; for example, the first and second directions may be understood as, respectively, the direction pointing from any point in area 3C to origin O and the direction pointing from any point in area 3L to origin O.

The sound source separator 11a just described generates each unit sound signal by reducing the signal level in the unnecessary band; instead, it may generate it by increasing the signal level in the necessary band, or by reducing the signal level in the unnecessary band and in addition increasing the signal level in the necessary band. Processing similar to that described above may be performed by use of, instead of the phase difference, the power difference between the left and right channels. The sound source separator 11a just described is provided with n sets of an unnecessary band eliminator and an IFFT section to generate n unit sound signals; instead, one set of an unnecessary band eliminator and an IFFT section may be assigned a plurality of unit sound signals and be used on a time division basis. This helps reduce the needed number of sets of an unnecessary band eliminator and an IFFT section to less than n. The sound source separator 11a just described generates each unit sound signal based on the detection signals of two microphones; instead, it may generate it based on the detection signals of three or more microphones arranged at different positions.

Instead of through directivity control as executed in the sound source separator 11a, by use of a stereophonic microphone capable of stereophonic sound collection by itself, the sound from each sound source may be collected individually so that a plurality of unit sound signals separate from one another may be acquired directly. Instead, by use of n directional microphones (microphones having directivity), with the high-sensitivity directions of the first to n-th directional microphones aligned with the first to n-th directions corresponding to the first to n-th sound sources, the sound from each sound source may be collected individually so that the first to n-th unit sound signals may be acquired directly in a form separate from one another.

Instead, in a case where the locations of the first to n-th sound sources are previously known, by use of a first to an n-th cordless microphone, the first to n-th cordless microphones may be arranged at the locations of the first to n-th sound sources so that the i-th cordless microphone may collect the sound of the i-th sound source (i=1, 2, . . . , (n−1), and n). In this way, by the first to n-th cordless microphones, the first to n-th unit sound signals corresponding to the first to n-th sound sources are acquired directly in a form separate from one another.

Instead, through independent component analysis, the first to n-th unit sound signals may be generated from the detection signals of a plurality of microphones (for example, the microphones 1L and 1R). In independent component analysis, on the assumption that no two or more sound signals from the same sound source occur at the same time, independence of sound sources from one another is relied upon to collect the sound signal of each sound source separately.

Sound source location information representing the first to n-th directions mentioned above, or representing the locations of the first to n-th sound sources, is added to the first to n-th unit sound signals outputted from the sound source separator 11. The sound source location information is used in the processing by the volume control amount setter 14 and the volume controller 15 in FIG. 3. The i-th direction, which represents the direction of the i-th sound source, is determined based on the above-mentioned phase difference, or the direction of the directivity of the above-mentioned stereo microphone, or the direction of the directivity of the above-mentioned directional microphone, in any case the one corresponding to the i-th sound source (i=1, 2, . . . , (n−1), and n). The location of the i-th sound source is determined based on the position of the above-mentioned cordless microphone corresponding to the i-th sound source (i=1, 2, . . . , (n−1), and n).

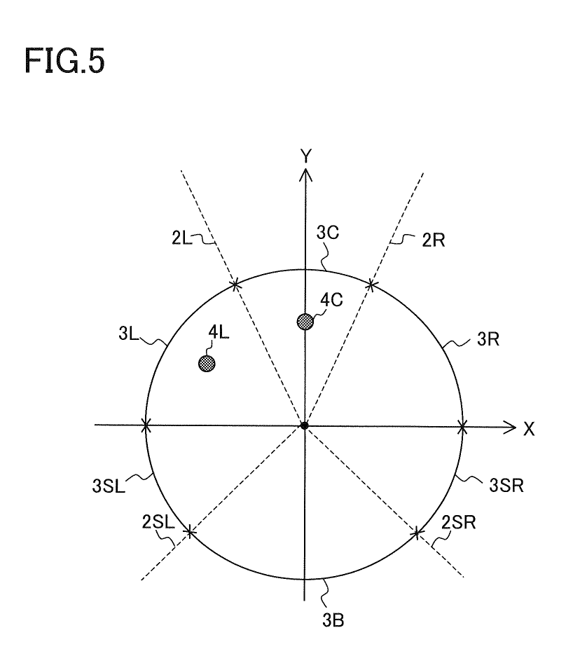

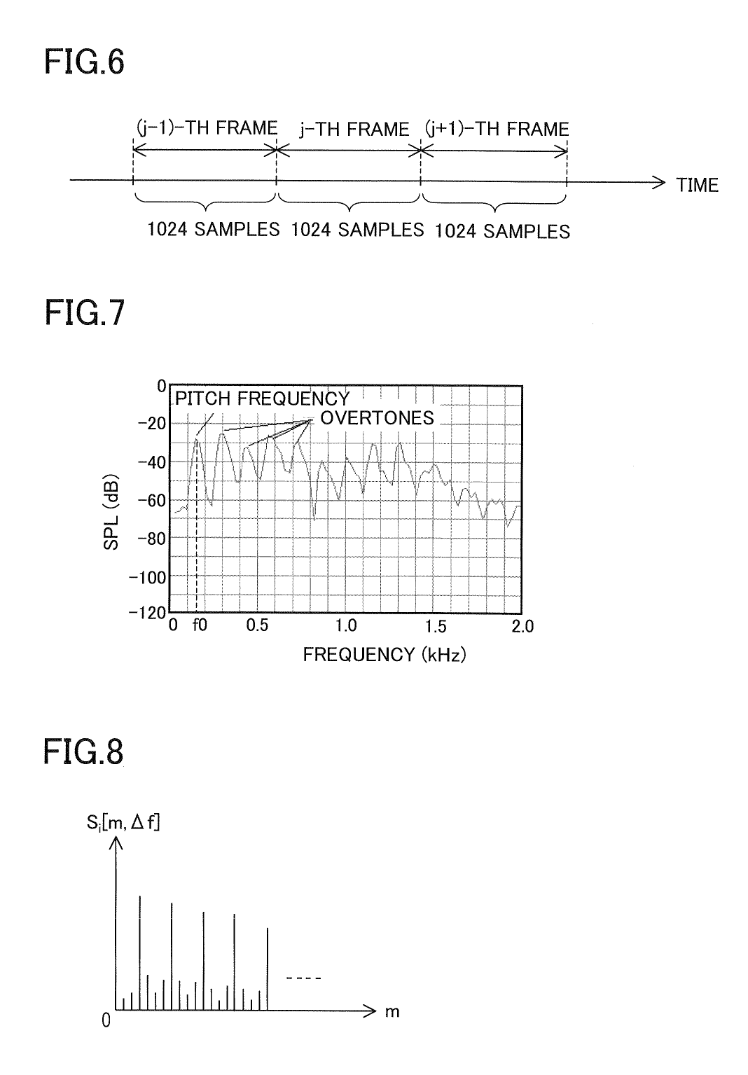

The unit sound signals outputted from the sound source separator 11 are digital sound signals in the time domain, and it is assumed that they are digitized at a sampling frequency of 48 kHz. As shown in FIG. 6, each unit sound signal in the time domain divides into units of 1024 samples, that is, units each lasting about 21.3 msec (≈1024×1/48 kHz), every 1024 samples forming one frame. Frames contiguous in the time domain are called a first frame, a second frame, a third frame, and so fourth in order of their occurrence.

### Sound Type Detector

Next, the function of the sound type detector 12 in FIG. 3 will be described. Based on the first to n-th unit sound signals outputted from the sound source separator 11, the sound type detector 12 discriminates the types of the first to n-th sound sources individually.

In applications such as digital video cameras and IC recorders, a sound signal conveying a human voice is of greatest interest. Music played in a recording environment may be of help in reproducing the atmosphere at the recording site, and therefore it is preferable to record it at a volume that does not mask a human voice. On the other hand, noise should be so controlled as to have as low a sound volume as possible. Accordingly, the embodiment under discussion deals with a method for classifying sound sources into three types, namely “human voice,” “music,” and “noise.”

The sound type detector 12 takes each of the first to n-th unit sound signals as of interest separately and, based on the unit sound signal of interest, discriminates the type of the sound source corresponding to that unit sound signal. The following description discusses a method for discriminating the type of the first sound source based on the first unit sound signal, and it should be understood that the types of the second to n-th sound sources are discriminated based on the second to n-th unit sound signals in a similar manner.

First, a method for checking whether or not the type of the first sound source is “human voice” will be described. Generally, a sound signal conveying a human voice has its power concentrated between about 100 Hz and about 4 kHz, and a voiced sound, in particular, has a harmonic structure composed of a pitch frequency, which is relatively low, accompanied by its overtones (harmonics). A pitch frequency denotes the fundamental frequency of the sound signal resulting from vibrations of the vocal cords.

FIG. 7 shows an example of the frequency spectrum of a sound signal conveying a human voice. In the frequency spectrum graph in FIG. 7, the horizontal axis represents frequency, and the vertical axis represents sound pressure level. As shown in FIG. 7, in the frequency spectrum of a human voice, frequencies at which the sound pressure level is maximal (locally maximal) and frequencies at which the sound pressure level is minimal (locally minimal) recur alternately at largely equal frequency intervals. Of the plurality of frequencies at which the sound pressure level is maximal, the lowest is the pitch frequency f0, and the sound pressure level has maximal values at the frequencies of its overtone components, namely f0×2, f0×3, f0×4, and so forth. With these characteristics taken into account, the first unit sound signal is subjected to frequency analysis and, if there exists a signal component having a harmonic structure in a predetermined frequency band, the type of the first sound source can then be judged to be “human voice.”

For the purpose of checking whether or not the type of the first sound source is “human voice,” many methods are well-known, and the sound type detector 12 may adopt any method including those well known. A brief description will now be given of one specific example of a usable method.

At time intervals of about 21.3 msec, that is, for every frame, the sound type detector 12 performs discrete Fourier transform on the first unit sound signal (see FIG. 6). The resulting signal representing the frequency spectrum of the first unit sound signal in the j-th frame is represented by Sⱼ[m·Δf]. Here, j is a natural number. Δf represents the sampling interval of frequencies in discrete Fourier transform. Suppose now that, through discrete Fourier transform on a unit sound signal, M signals are calculated at intervals of Δf (where M is an integer of 2 or more, and for example M=256). Then, m takes every integer in the range of 0≦m≦(M−1), and thus the frequency spectrum of the first unit sound signal in the j-th frame is composed of signals S_{j[}0·Δf] to Sⱼ[M−1·Δf] in the frequency domain. FIG. 8 shows an example of a signal Sⱼ[m·Δf] representing a frequency spectrum.

The sound type detector 12 performs self-correlation processing on a predetermined band component in the thus obtained frequency spectrum. For example, it searches for a pitch frequency in, of the signals S_{j[}0·Δf] to Sⱼ[M−1·Δf], those in the band of 100 Hz to 4 kHz, and also searches for any overtone component of the pitch frequency. If a pitch frequency, and any overtone component of it, is found to be present, the type of the first sound source corresponding to the first unit sound signal is judged to be “human voice”; if not, the type of the first sound source is judged not to be “human voice.”

Next, a method for checking whether or not the type of the first sound source is “music” will be described. Generally, a sound signal conveying music is a wide-band signal, and in addition has a certain periodicity. Accordingly, if the first unit sound signal has a comparatively wide band, and in addition has a certain periodicity in the time domain, the type of the first sound source can be judged to be “music.”

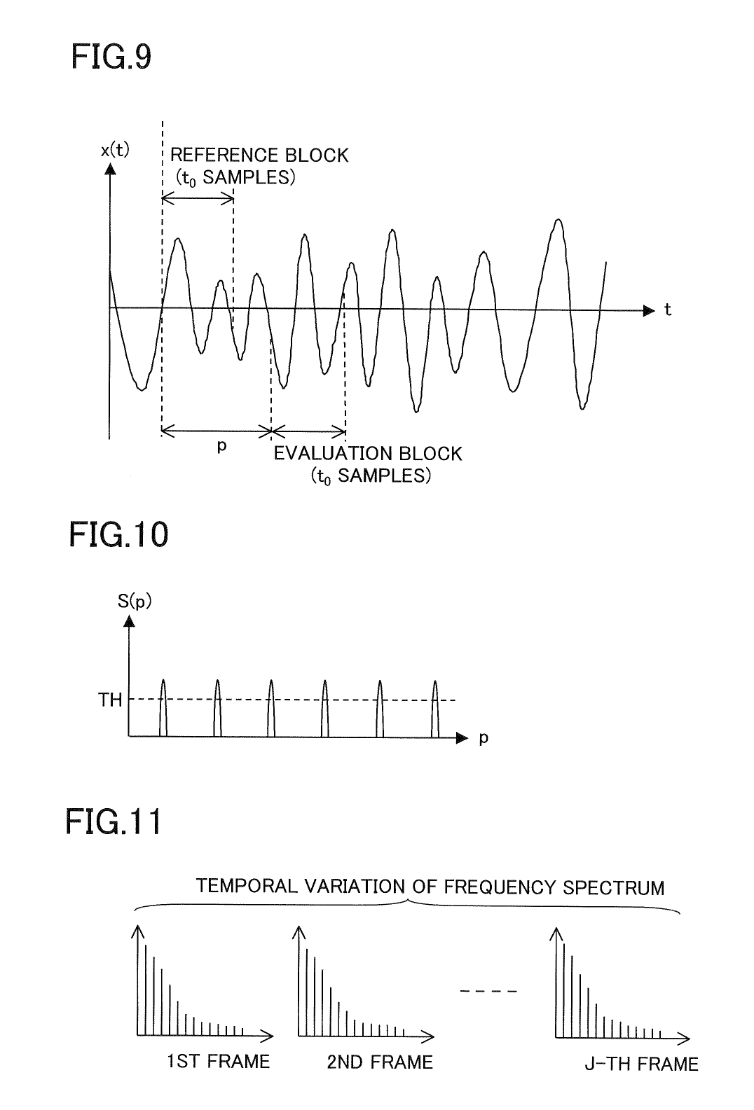

A description will now be given of a specific method. The first unit sound signal is composed of a string of digital sound signals digitized at 48 kHz, and of those digital sound signals, the signal value or power of the t-th as counted from a reference time point is represented by x(t) (where t is an integer). Then, as shown in FIG. 9, using as a reference block the block composed of the first to t₀-th x(t)'s as counted from the reference time point, self-correlation is calculated (where t₀ is an integer of 2 or more). Specifically, for the t₀-th and following x(t)'s, an evaluation block composed of t₀ consecutive x(t)'s is defined and, while the evaluation block is moved along the time axis, the correlation between the reference block and the evaluation block is calculated. More specifically, a self-correlation value S(p) is calculated according to formula (1) below. The self-correlation value S(p) is a function of a variable p, which determines the position of the evaluation block (where p is an integer).

$$S ( p ) = \frac{1}{{t}_{0}} {\sum }_{t = 1}^{{t}_{0}} \{ x ( t ) \cdot x ( t + p ) \} \qquad ( 1 )$$

FIG. 10 shows the dependence of the calculated self-correlation value S(p) on the variable p. In FIG. 10, the horizontal and vertical axes represent the variable p and the self-correlation value S(p) respectively. FIG. 10 corresponds to a case where the type of the first sound source is “music.” In this case, as the variable p varies, the self-correlation value S(p) takes a large value periodically. If the self-correlation value S(p) calculated with respect to the first unit sound signal is found to exceed a predetermined threshold value TH periodically, the sound type detector 12 judges the type of the first sound source to be “music”; if not, the sound type detector 12 judges the type of the first sound source not to be “music.” For example, if the intervals at which the variable p fulfills the inequality “S(p)>TH” are equal (or substantially equal), it can be judged that the self-correlation value S(p) exceeds the predetermined threshold value TH periodically.

The band of the first unit sound signal may also be taken into consideration. For example, even if the self-correlation value S(p) calculated with respect to the first unit sound signal is found to exceed the predetermined threshold value TH periodically, when the first unit sound signal is found to contain completely or almost no signal component in a predetermined frequency band, the type of the first unit sound signal may be judged not to be “music.” For example, when the largest value of the signal level of the first unit sound signal in a frequency band of 5 kHz or higher but 15 kHz or lower is equal to or less than a predetermined level, it can be judged that the first unit sound signal contains completely or almost no signal component in a predetermined frequency band.

Next, a method for checking whether or not the type of the first sound source is “noise” will be described. Noise, as exemplified by noise made by an air conditioner and circuit noise (sinusoidal noise), is steady and shows little variation in frequency characteristics. Accordingly, by checking whether or not the first unit sound signal has such signal characteristics, it is possible to check whether or not it conveys noise.

Specifically, one possible method is as follows. Frames corresponding to several seconds are taken as of interest, and the first unit sound signal in the frames of interest is subjected to discrete Fourier transform frame by frame. It is here assumed that the frames of interest are a first to a J-th frame (where J is an integer, and for example J=200). Then, according to formula (2) below, a noise evaluation value E_{NOISE} is calculated and, if the noise evaluation value E_{NOISE} is equal to or less than a predetermined reference value, it is judged that there is little temporal variation in frequency characteristics, and thus the type of the first sound source is judged to be “noise”; otherwise, the type of the first sound source is judged not to be “noise.”

$${E}_{NOISE} = {\sum }_{m = 0}^{M - 1} {\sum }_{j = 1}^{J} \vert {S}_{AVE} [ m \cdot Δ f ] - {S}_{j} [ m \cdot Δ f ] \vert \qquad ( 2 )$$

Here, S_{AVE}[m·Δf] represents the average, through the first to J-th frames, of the signal component of frequency (m×Δf) in the first unit sound signal. Specifically, S_{AVE}[m·Δf] is the average value of S₁[m·Δf] to S_{J}[m·Δf]. As shown in FIG. 11, since the frequency spectrum of noise has little temporal variation, the noise evaluation value E_{NOISE} calculated with respect to noise takes a comparatively small value.

If, according to the methods described above, the type of the first sound source is judged not to be any of “human voice,” “music”, and “noise,” it is then judged to be a fourth type.

### Volume Detector

Next, the function of the volume detector 13 in FIG. 3 will be described. The volume detector 13 detects the signal levels of the first to n-th unit sound signals outputted from the sound source separator 11, and thereby detects the sound volumes of the sound sources as observed in the unit sound signals respectively. For that purpose, the band of each unit sound signal is divided into eight bands, and the signal level is detected in each of the so divided bands.

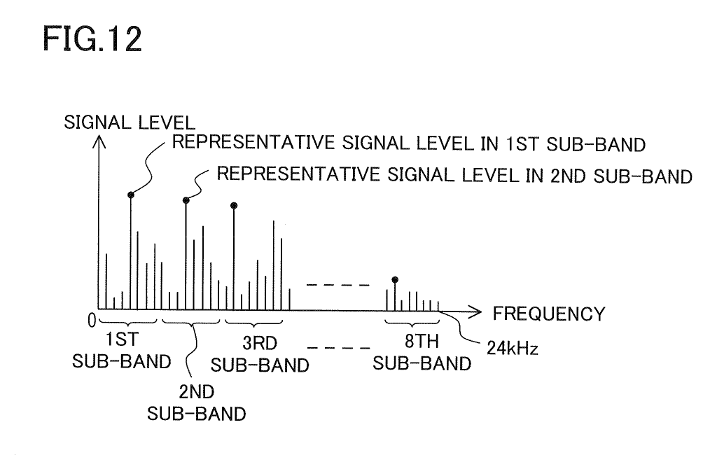

More specifically, for each unit sound signal, the signal level of the unit sound signal is detected in the following manner. For the sake of clarity of description, the following description of a signal level detection method takes the first unit sound signal alone as of interest. The first unit sound signal is subjected to frame-by-frame discrete Fourier transform, thereby to calculate frame-by-frame frequency spectra. Since the first unit sound signal has a sampling frequency of 48 kHz, the calculated frequency spectrum has a band of 0 to 24 kHz. This band (that is, of 0 to 24 kHz) is divided into eight bands, and the so divided bands are called a first, a second, . . . , and an eighth sub-band in increasing order of frequency (see FIG. 12).

For each frame, and in addition for each sub-band, the volume detector 13 identifies the largest value of the signal level of the frequency spectrum. For example, in a case where the first sub-band is a band of 0 kHz or higher but (10·Δf) kHz or lower, based on the signals S_{1[}0·Δf] to S_{1[}10·Δf] in the frequency spectrum, it is identified at which of the frequencies 0·Δf, 1·Δf, . . . , 9·Δf, and 10·Δf, the signal level is largest, and the signal level at the thus identified frequency is extracted as a representative signal level in the first sub-band in the first frame (see FIG. 12). This representative signal level is handled as the signal level in the first sub-band in the first frame which is to be detected by the volume detector 13. The representative signal levels in the second to eighth sub-bands in the first frame are extracted likewise and, furthermore, similar extraction processing is executed for one after another of the frames succeeding the first frame.

While the above description deals with the first unit sound signal, the representative signal levels of the second to n-th unit sound signals are detected in a similar manner as that of the first unit sound signal.

### Volume Control Amount Setter

Next, the function of the volume control amount setter 14 in FIG. 3 will be described. First, based on the sound source location information mentioned previously and the types of the individual sound sources discriminated by the sound type detector 12, according to prescribed table data, the volume control amount setter 14 determines, for each unit sound signal, an upper-limit amount of amplification. Each unit sound signal is amplified by the volume controller 15, and the upper-limit amount of amplification defines the upper-limit value for the amplification. The signal level of a unit sound signal may be diminished by the volume controller 15, in which case the variation in the signal level is negative amplification. The amount of amplification may be read as amount of control or amount of adjustment.

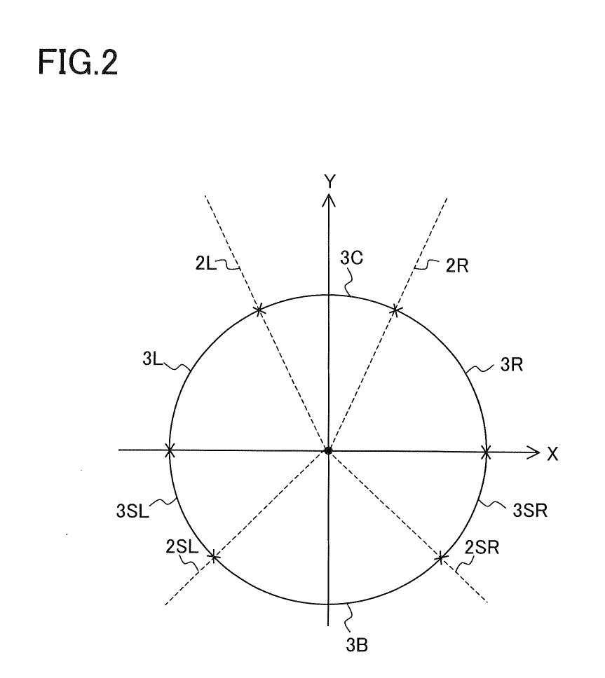

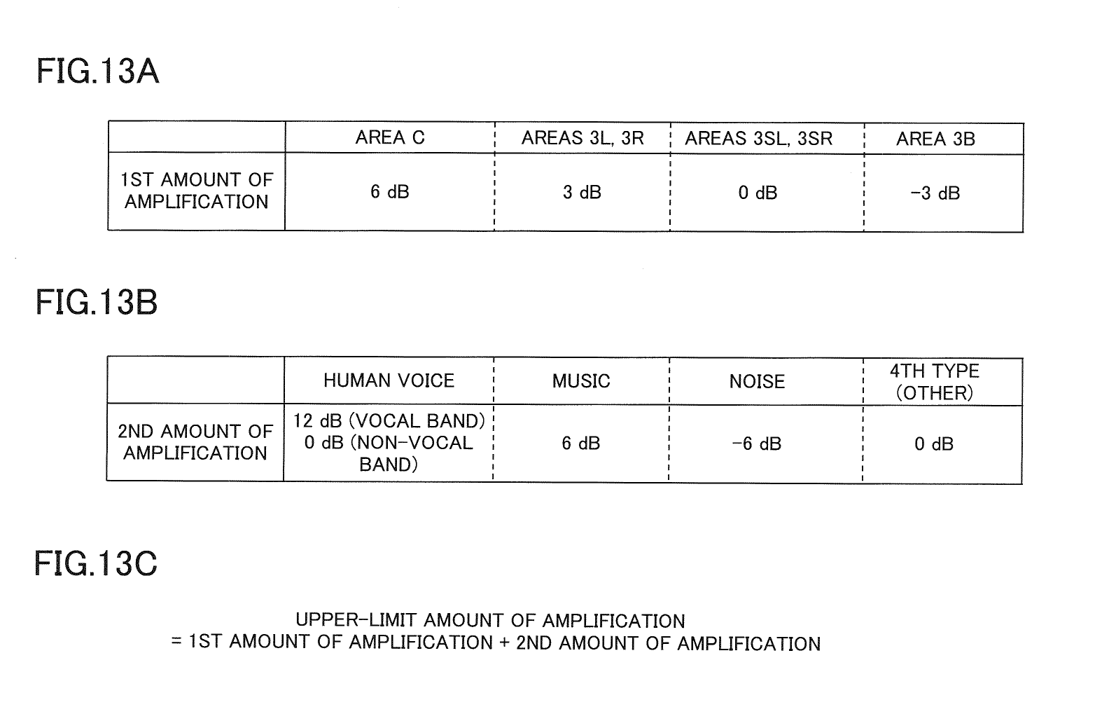

Based on the sound source location information, it is identified in which of the six areas 3C, 3L, 3SL, 3B, 3SR, and 3R the individual sound sources are located (see FIG. 2), and according to the results of identification, for each unit sound signal, a first amount of amplification is determined. FIG. 13A shows the contents of table data for determining the first amount of amplification. Specifically, with each of the first to n-th unit sound signals taken as of interest individually, if the sound source corresponding to the unit sound signal of interest is located in area 3C, or in area 3L or 3R, or in area 3SL or 3SR, or in area 3B, the first amount of amplification is set at 6 dB, or 3 dB, or 0 dB, or (−3 dB) respectively in terms of voltage ratio.

Based on the types of the individual sound sources discriminated by the sound type detector 12, for each unit sound signal, a second amount of amplification is determined. FIG. 13B shows the contents of table data for determining the second amount of amplification. Specifically, with each of the first to n-th unit sound signals taken as of interest individually, if the type of the sound source corresponding to the unit sound signal of interest is “human voice,” or “music,” or “noise,” or “fourth type,” the second amount of amplification is set at 12 dB, or 6 dB, or (−6 dB), 0 dB respectively in terms of voltage ratio. It should however be noted here that, if the type of the sound source corresponding to the unit sound signal of interest is “human voice,” the second amount of amplification is set at 12 dB only in a vocal band out of the entire band of the unit sound signal of interest, and the second amount of amplification is set at 0 dB in a non-vocal band out of the entire band of the unit sound signal of interest. A vocal band is a band in which the power of a human voice is concentrated. For example, the band of 10 Hz or higher but 4 kHz or lower is set as the vocal band, and the band other than that band is set as the non-vocal band.

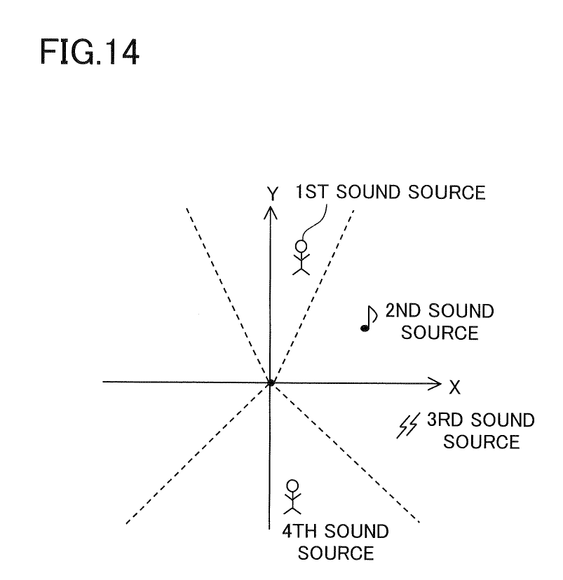

As shown in FIG. 13C, the volume control amount setter 14 sets the upper-limit amount of amplification at the sum of the first and second amounts of amplification. Consider now a case as shown in FIG. 14 (see also FIG. 2), specifically a case where n=4, where the sound source location information indicates that the first, second, third, and fourth sound sources are located in areas 3C, 3R, 3SR, and 3B respectively, and in addition where the sound type detector 12 has discriminated the types of the first, second, third, and fourth sound sources to be “human voice,” “music,” “noise,” and “human voice” respectively. For the sake of convenience, this case assumed here will be called assumption α. Under assumption α, the upper-limit amount of amplification with respect to the first unit sound signal is set at 18 dB (=6 dB+12 dB) in the vocal band and at 6 dB (=6 dB+0 dB) in the non-vocal band; the upper-limit amounts of amplification with respect to the second and third unit sound signals are set at 9 dB (=3 dB+6 dB) and −6 dB (=0 dB−6 dB) respectively; the upper-limit amount of amplification with respect to the fourth unit sound signal is set at 9 dB (=−3 dB+12 dB) in the vocal band and at −3 dB (=−3 dB+0 dB) in the non-vocal band.

A sound signal, and hence a unit sound signal, is a voltage signal, and the larger the amplitude of the voltage, the higher the corresponding sound volume and signal level. The unit “dB (decibel)” used in the description of the volume control amount setter 14 and the volume controller 15 represents the voltage ratio of a signal of interest relative to a voltage signal having a predetermined full-scale amplitude.

After determining the upper-limit amounts of amplification, the volume control amount setter 14 determines the actual amounts of amplification such that, through amplification processing by the volume controller 15, the voltage amplitudes of the representative signal levels in the first to eighth sub-bands respectively as detected by the volume detector 13 become −20 dB (that is, one-tenth of the full-scale amplitude). The processing here for determination of the amounts of amplification and for amplification according to the determined amounts of amplification is executed for each unit sound signal, and in addition for each sub-band.

So that the actual amounts of amplification may not exceed the upper-limit amounts of amplification, however, a limit is posed on the amounts of amplification determined. Moreover, to prevent a sharp change in sound volume from causing an unnatural feeling to the listener, the magnitude of variation in amount of amplification between consecutive frames is limited to 6 dB or less. Furthermore, to prevent the sound from area 3C, where a main sound source is supposed to be located, from being masked by a sound from another area, a limit is posed on the amounts of amplification with respect to the sound sources in areas 3L, 3SL, 3B, 3SR, and 3R such that those amounts of amplification are about 6 dB lower than the amounts of amplification with respect to the sound source in area 3C. Due to these limits, after amplification processing by the volume controller 15, the voltage amplitudes of the representative signal levels in the individual sub-bands may differ from their target amplitudes (that is, −20 dB).

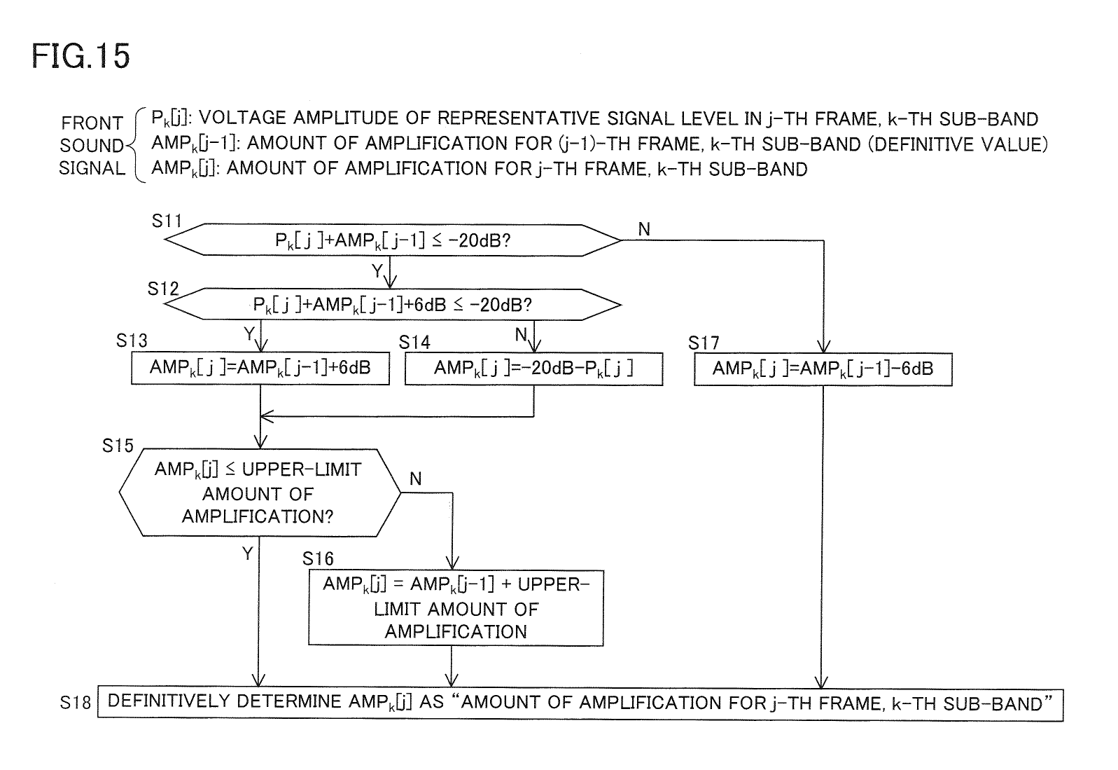

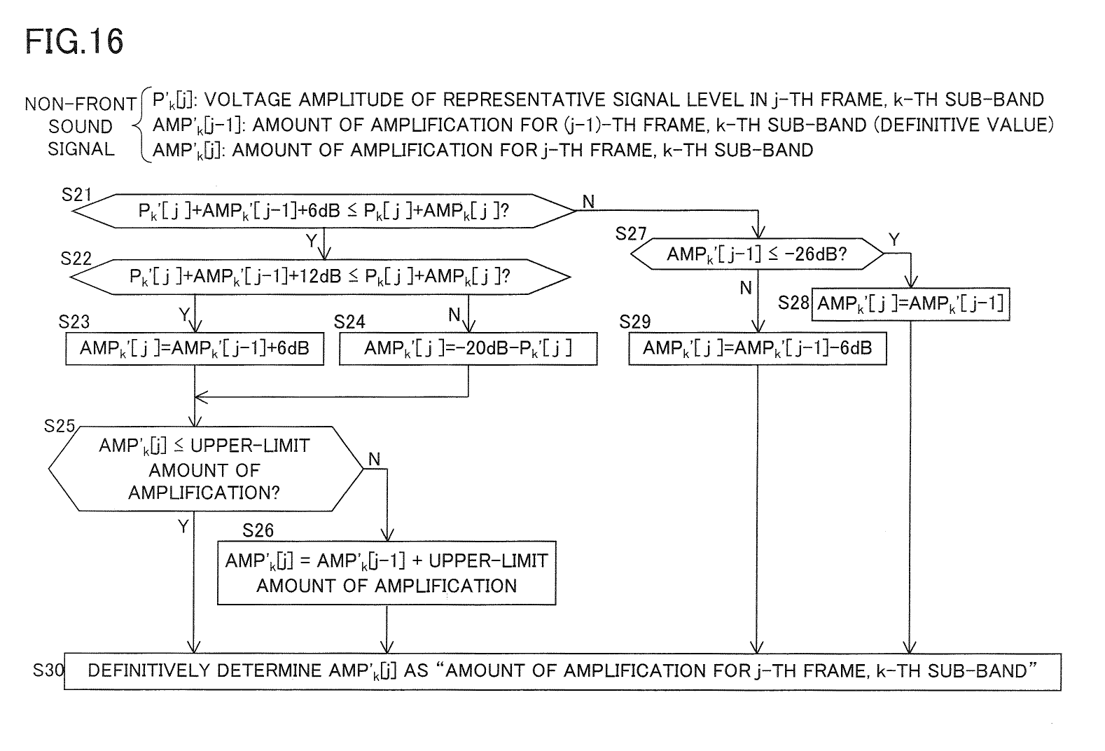

With reference to FIGS. 15 and 16, a method for determining the amounts of amplification which meets the requirements mentioned above will be described in detail. FIG. 15 is a flow chart of a procedure for calculating the amounts of amplification with respect to the unit sound signal the sound source corresponding to which is located in area 3C. FIG. 16 is a flow chart of a procedure for calculating the amounts of amplification with respect to the unit sound signal the sound source corresponding to which is located in area 3L, 3SL, 3B, 3SR, or 3R. The unit sound signal the sound source corresponding to which is located in area 3C will be called a front sound signal, and the unit sound signal the sound source corresponding to which is located in area 3L, 3SL, 3B, 3SR, or 3R will be called a non-front sound signal. Under assumption α, the first unit sound signal is a front sound signal, and the second to fourth unit sound signals are each a non-front sound signal. The amount of amplification for a front sound signal is determined, for each sub-band, through the processing at steps S11 through S18 in FIG. 15, and the amount of amplification for a non-front sound signal is determined, for each sub-band, through the processing at steps S21 through 30 in FIG. 16.

With reference to FIG. 15, the processing at steps S11 through S18, which is executed with respect to a front sound signal (for example, the first unit sound signal under assumption α), will be described. Here, the voltage amplitude of the representative signal level in the k-th sub-band of the front sound signal in the j-th frame is represented by Pₖ[j]. Pₖ[j] is the voltage ratio, as expressed logarithmically, of that voltage amplitude relative to the full-scale amplitude. Accordingly, Pₖ[j] is in the unit of dB. Pₖ[j] is detected by the volume detector 13. Here, k takes every integer of 1 or more but 8 or less.

Through the processing at steps S11 through S18 executed with respect to the (j−1)-th frame prior to the processing at steps S11 through S18 with respect to the j-th frame, the amount of amplification with respect to the k-th sub-band of the front sound signal in the (j−1)-th frame has been determined, and this determined value is represented by AMPₖ[j−1]. A preliminarily or definitively determined value of the amount of amplification with respect to the k-th sub-band of the front sound signal in the j-th frame is represented by AMPₖ[j]. AMPₖ[j−1] and AMPₖ[j] also are in the unit of dB.

First, at step S11, the volume control amount setter 14 checks whether or not a first inequality “Pₖ[j]+AMPₖ[j−1]≦−20 dB” holds. That is, it checks whether or not, if the signal in the j-th frame is amplified by the amount of amplification determined with respect to the (j−1)-th frame, the voltage amplitude of the signal after amplification will be equal to or less than a predetermined full-scale amplitude. If the first inequality holds, that is, if the voltage amplitude that will be obtained when the voltage amplitude Pₖ[j] is amplified by the amount of amplification AMPₖ[j−1] is equal to or less than −20 dB, then an advance is made to step S12 to execute the processing at step S12; on the other hand, if the first inequality does not hold, an advance is made to step S17 to execute the processing at step S17.

At step S12, the volume control amount setter 14 checks whether or not a second inequality “Pₖ[j]+AMPₖ[j−1]+6 dB ≦−20 dB” holds. If the second inequality holds, that is, if the voltage amplitude that will be obtained when the voltage amplitude Pₖ[j] is amplified by the amount of amplification (AMPₖ[j−1]+6 dB) is equal to or less than −20 dB, then, at step S13, (AMPₖ[j−1]+6 dB) is substituted in AMPₖ[j], and then an advance is made to step S15; on the other hand, if the second inequality does not hold, then, at step S14, (−20 dB−Pₖ[j]) is substituted in AMPₖ[j], and then an advance is made to step S15.

At step S15, the amount of amplification AMPₖ[j] preliminarily set at step S13 or S14 is equal to or less than the upper-limit amount of amplification is checked, and if the preliminarily set amount of amplification AMPₖ[j] is equal to or less than the upper-limit amount of amplification, the preliminarily set amount of amplification AMPₖ[j] is definitively determined as the amount of amplification with respect to the k-th sub-band of the front sound signal in the j-th frame (step S18).

On the other hand, if the amount of amplification AMPₖ[j] preliminarily set at step S13 or S14 is more than the upper-limit amount of amplification, then, at step S16, the amount of amplification AMPₖ[j] is corrected. Specifically, by newly substituting in the amount of amplification AMPₖ[j] the value obtained by adding the upper-limit amount of amplification to the amount of amplification AMPₖ[j−1], the amount of amplification AMPₖ[j] is corrected (step S16), and then the thus corrected amount of amplification AMPₖ[j] is definitively determined as the amount of amplification with respect to the k-th sub-band of the front sound signal in the j-th frame (step S18).

If, at step S11, it is found that the first inequality does not hold, then, at step S17, the value obtained by reducing the amount of amplification AMPₖ[j−1] by 6 dB is substituted in the amount of amplification AMPₖ[j], and the resulting amount of amplification AMPₖ[j] (=AMPₖ[j−1]−6 dB) is definitively determined as the amount of amplification with respect to the k-th sub-band of the front sound signal in the j-th frame (step S18).

With reference to FIG. 16, the processing at steps S21 through S30, which is executed with respect to a non-front sound signal (for example, the second unit sound signal under assumption α), will be described. Here, the voltage amplitude of the representative signal level in the k-th sub-band of the non-front sound signal in the j-th frame is represented by P′ₖ[j]. P′ₖ[j] is the voltage ratio, as expressed logarithmically, of that voltage amplitude relative to the full-scale amplitude. Accordingly, P′ₖ[j] is in the unit of dB. P′ₖ[j] is detected by the volume detector 13. Here, k takes every integer of 1 or more but 8 or less.

Through the processing at steps S21 through S30 executed with respect to the (j−1)-th frame prior to the processing at steps S21 through S30 with respect to the j-th frame, the amount of amplification with respect to the k-th sub-band of the non-front sound signal in the (j−1)-th frame has been determined, and this determined value is represented by AMP′ₖ[j−1]. A preliminarily or definitively determined value of the amount of amplification with respect to the k-th sub-band of the non-front sound signal in the j-th frame is represented by AMP′ₖ[j]. AMP′ₖ[j−1] and AMP′ₖ[j] also are in the unit of dB.

First, at step S21, the volume control amount setter 14 checks whether or not a third inequality “P′ₖ[j]+AMP′ₖ[j−1]+6 dB≦Pₖ[j]+AMPₖ[j]” holds. In the third inequality, and also in a fourth inequality, which will be described later, Pₖ[j] is the same as in the description of the flow chart of FIG. 15, and AMPₖ[j] is the amount of amplification with respect to the k-th sub-band of the front sound signal in the j-th frame as definitively determined at step S18 in FIG. 15. If the third inequality holds, that is, if the voltage amplitude that will be obtained when the voltage amplitude P′ₖ[j] is amplified by the amount of amplification (AMP′ₖ[j−1]+6 dB) is equal to or less than the voltage amplitude that will be obtained when the voltage amplitude Pₖ[j] is amplified by the amount of amplification AMPₖ[j], then an advance is made to step S22 to execute the processing at step S22; on the other hand, if the third inequality does not hold, an advance is made to step S27 to execute the processing at step S27.

At step S22, the volume control amount setter 14 checks whether or not a fourth inequality “P′ₖ[j]+AMP′ₖ[j−1]+12 dB≦Pₖ[j]+AMPₖ[j]” holds. If the fourth inequality holds, then, at step S23, (AMP′ₖ[j−1]+6 dB) is substituted in AMP′ₖ[j], and then an advance is made to step S25; on the other hand, if the fourth inequality does not hold, then, at step S24, (−20 dB−P′ₖ[j]) is substituted in AMP′ₖ[j], and then an advance is made to step S25.

At step S25, the amount of amplification AMP′ₖ[j] preliminarily set at step S23 or S24 is equal to or less than the upper-limit amount of amplification is checked, and if the preliminarily set amount of amplification AMP′ₖ[j] is equal to or less than the upper-limit amount of amplification, the preliminarily set amount of amplification AMP′ₖ[j] is definitively determined as the amount of amplification with respect to the k-th sub-band of the non-front sound signal in the j-th frame (step S30).

On the other hand, if the amount of amplification AMP′ₖ[j] preliminarily set at step S23 or S24 is more than the upper-limit amount of amplification, then, at step S26, the amount of amplification AMP′ₖ[j] is corrected. Specifically, by newly substituting in the amount of amplification AMP′ₖ[j] the value obtained by adding the upper-limit amount of amplification to the amount of amplification AMP′ₖ[j−1], the amount of amplification AMP′ₖ[j] is corrected (step S26), and then the thus corrected amount of amplification AMP′ₖ[j] is definitively determined as the amount of amplification with respect to the k-th sub-band of the non-front sound signal in the j-th frame (step S30).

If, at step S21, it is found that the third inequality does not hold, then, at step S27, whether or not yet another, namely fifth, inequality “AMP′ₖ[j−1]≦−26 dB” holds is checked. If the fifth inequality holds, then, at step S28, the amount of amplification AMP′ₖ[j−1] is, intact, substituted in the amount of amplification AMP′ₖ[j], and the resulting amount of amplification AMP′ₖ[j] (=AMP′ₖ[j−1]) is definitively determined as the amount of amplification with respect to the k-th sub-band of the non-front sound signal in the j-th frame (step S30). On the other hand, if the fifth inequality does not hold, then, at step S29, the value obtained by reducing the amount of amplification AMP′ₖ[j−1] by 6 dB is substituted in the amount of amplification AMP′ₖ[j], and the resulting amount of amplification AMP′ₖ[j] (=AMP′ₖ[j−1]−6 dB) is definitively determined as the amount of amplification with respect to the k-th sub-band of the non-front sound signal in the j-th frame (step S30).

### Volume Controller

Next, the function of the volume controller 15 in FIG. 3 will be described. By the amount of amplification determined for each unit sound signal, and in addition for each sub-band, by the volume control amount setter 14, the volume controller 15 amplifies the first to n-th unit sound signals one by one, and in addition sub-band by sub-band. This amplification is performed in the frequency domain. Thus, the amplification is performed on the frequency spectra of the individual unit sound signals obtained by discrete Fourier transform, and the frequency spectra after the amplification are then converted back, by inverted discrete Fourier transform, into signals in the time domain. In this way, the first to n-th unit sound signals having their signal levels corrected are outputted from the volume controller 15. The corrected sound signals, that is, the output sound signals of the volume controller 15, are thus composed of the first to n-th unit sound signals after signal level correction.

As described above, based on the directions in which the first to n-th sound sources are located, or the locations at which they are present, and based on the type of the individual sound sources and the signal levels of the unit sound signals corresponding those sound sources, the sound signal processing device 10 determines the amount of amplification for each unit sound signal, and in addition for each sub-band, to adjust the signal levels of the individual unit sound signals, and thereby adjusts individually the sound volumes of the sound sources in the target sound signals.

### Examples of Application in Various Appliances

A sound signal processing device 10 as described above is incorporated in any appliance that employs detection signals of a plurality of microphones. Appliances that employ detection signals of a plurality of microphones include recording devices (such as IC recorders), image shooting devices (such as digital video cameras), and sound signal playback devices. An image shooting device may be designed to have the capabilities of a recording device, or a sound signal playback device, or both. A recording device, an image shooting device, or a sound signal playback device may be integrated into a portable terminal (such as a portable telephone).

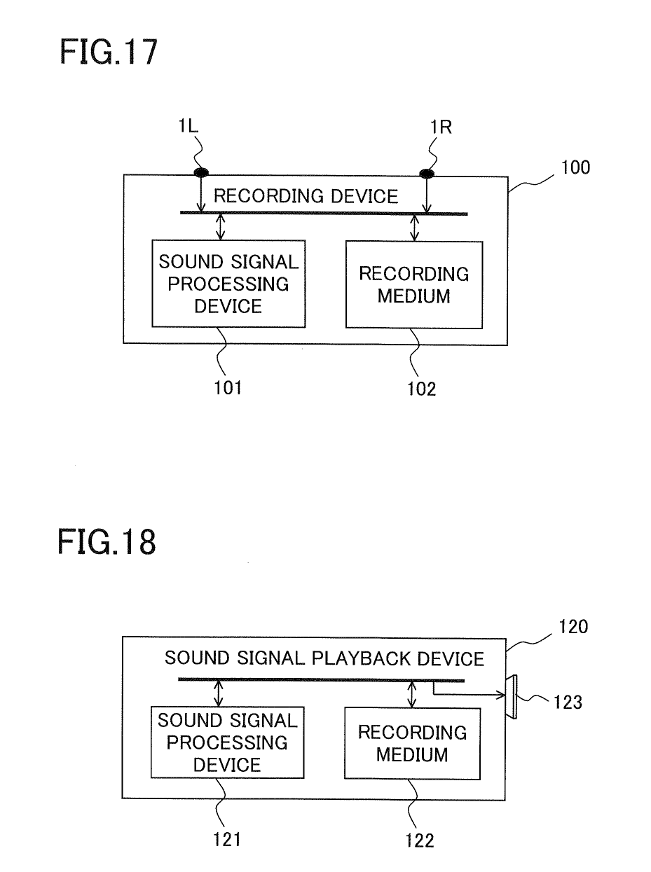

As an example, FIG. 17 shows a schematic configuration diagram of a recording device 100. The recording device 100 is provided with a sound signal processing device 101, a recording medium 102 such as a magnetic disk or memory card, and microphones 1L and 1R disposed at different positions on a body of the recording device 100. Usable as the sound signal processing device 101 here is the sound signal processing device 10 described above. The sound signal processing device 101 generates corrected sound signals from the detection signals of the microphones 1L and 1R, and records the corrected sound signals to the recording medium 102.

For another example, FIG. 18 shows a schematic configuration diagram of a sound signal playback device 120. The sound signal playback device 120 is provided with a sound signal processing device 121, a recording medium 122 such as a magnetic disk or memory card, and a speaker section 123. It is here assumed that the recording medium 122 has recorded to it detection signals from microphones 1L and 1R. Usable as the sound signal processing device 121 here is the sound signal processing device 10 described above. In the sound signal playback device 120, however, the detection signals of the microphones 1L and 1R as read from the recording medium 122 are fed to the sound signal processing device 121, and from the detection signals of the microphones 1L and 1R thus fed to it, the sound signal processing device 121 generates corrected sound signals.

The corrected sound signals generated in the sound signal playback device 120 are played back and outputted, in the form of sounds, from the speaker section 123. The corrected sound signals are, in the form of stereophonic or multiple-channel signals composed of n sound signals (the first to n-th unit sound signals after signal level correction) having directivity in different directions, played back and outputted from the speaker section 123 or a speaker section (unillustrated) provided externally to, or outside, the sound signal playback device 120. The corrected sound signals generated in the sound signal playback device 120 may be recorded to the recording medium 122.

To play back and output stereophonic or multiple-channel signals, the speaker section 123 comprises a plurality of speakers (a similar description applies to the speaker section 146 described later). The sound signal playback device 120 may be realized with a computer together with software running on it. The capabilities of the recording device 100 and the sound signal playback device 120 may be integrated to form a recording/playback device.

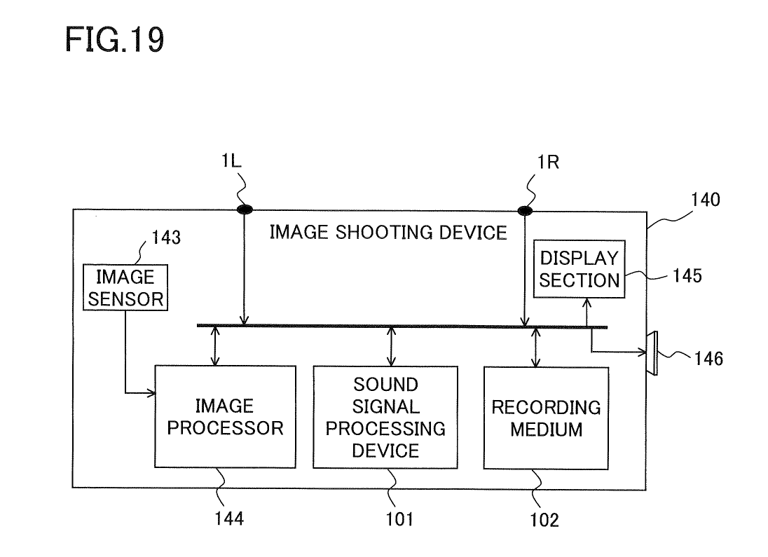

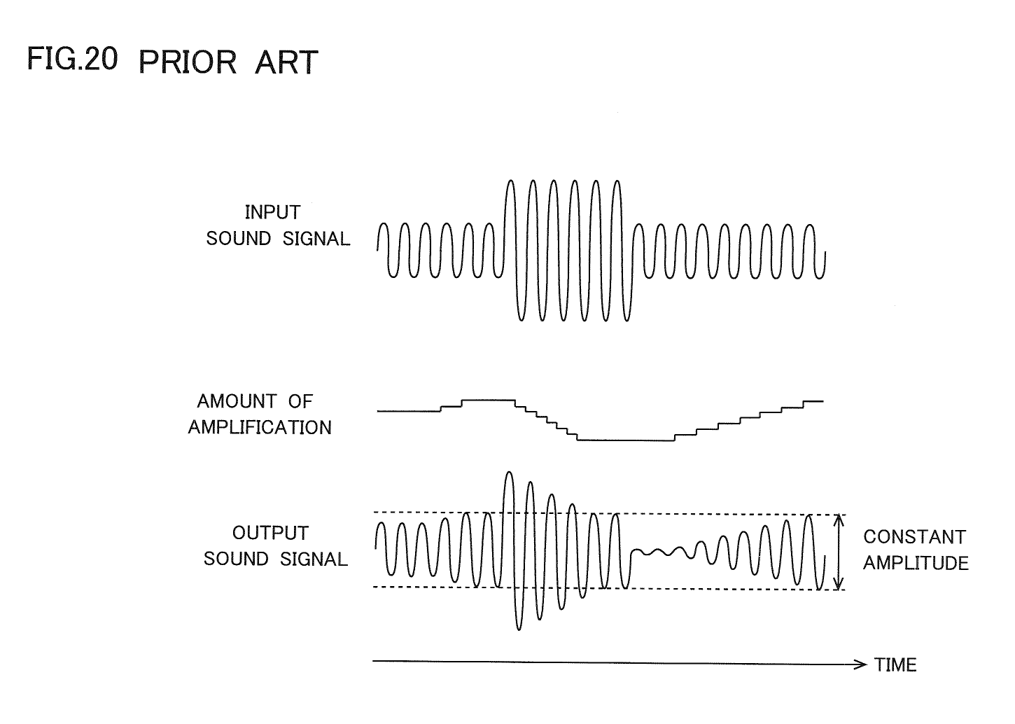

For yet another example, FIG. 19 shows a schematic configuration diagram of a image shooting device 140. The image shooting device 140 is formed by adding, to the components of the recording device 100 in FIG. 17, an image sensor 143 comprising a CCD (charge-coupled device) or CMOS (complementary metal oxide semiconductor) image sensor or the like, an image processor 144 which applies predetermined image processing to an image obtained by shooting by use of the image sensor 143, a display section 145 which displays a shot image, a speaker section 146 which outputs sounds, etc. The sound signal processing device 101, the recording medium 102, and the microphones 1L and 1R provided in the image shooting device 140 are the same as those in the recording device 100. The microphones 1L and 1R are disposed at different positions on a body of the image shooting device 140.

By use of the image sensor 143, the image shooting device 140 shoots a moving or still image according to a subject. The image signal (for example, a video signal in the YUV format) representing the moving or still image is recorded via the image processor 144 to the recording medium 102. In particular, when a moving image is shot, corrected sound signals based on the detection signals of the microphones 1L and 1R are, in a form temporally associated with the image signal of the moving image, recorded to the recording medium 102. The image shooting device 140 is also provided with the capabilities of a sound signal playback device for playing back sound signals (corrected sound signals) recorded on the recording medium 102. Thus, it can playback, by use of the display section 145 and the speaker section 146, a shot image along with corrected sound signals. The detection signals of the microphones 1L and 1R themselves may instead be, in a form temporally associated with the image signal of a moving image, recorded to the recording medium 102, in which case, when the moving image is played back, corrected sound signals are generated from the detection signals of the microphones 1L and 1R as recorded on the recording medium 102.

The image shooting device 140 shoots a subject located in the positive direction of Y axis as seen from origin O (see FIG. 1). For example, of areas 3C, 3L, 3SL, 3B, 3SR, and 3R, only area 3C lies within the field of view of the image shooting device 140 (see FIG. 2). Depending on the angle of view of the image shooting device 140, however, parts of areas 3L and 3R may also lie within the field of view of the image shooting device 140, or only part of area 3C may lie within the field of view of the image shooting device 140.

In this embodiment, according to the directions (or locations) of sound sources, and according to the types of the sound sources, the sound volumes of the individual sound sources are adjusted in each of different frequency bands. This makes it possible to record or play back a necessary sound (mainly, a human voice) at a relatively high volume and an unnecessary sound (such as noise) at a relatively low volume. In a case where a sound source of noise is located in a particular direction, through discrimination of different types of sound, the sound volume of noise is reduced, and this reduces the influence of noise in the sound signals that are eventually recorded or played back. On the other hand, a background sound such as music is recorded at a proper volume that does not mask the necessary sound (mainly, a human voice), and this permits playback with presence.

With the second conventional method described earlier, which involves separate sound volume control in each of discrete frequency bands, it is possible to reduce a noise component present in a particular frequency band, but when the frequencies of a noise component and of a necessary signal component overlap, it is impossible to reduce the noise component alone. By contrast, in this embodiment, sound volume adjustment (signal level adjustment) is performed according to the directions (or locations) of sound sources, and also according to the types of the sound sources, and thus it is possible to reduce a noise component alone.

Moreover, with an image shooting device according to this embodiment, it is possible to record or play back, loud and clearly, a sound that matches a shot image. In particular, the voice of a person in the front direction who appears in a shot image is recorded or played back at a higher volume than other sounds, and this makes easier to listen to the sound related to the subject to which the shooter is paying attention.

### Embodiment 2

Next, a second embodiment (Embodiment 2) of the invention will be described. Also in Embodiment 2, the sound signal processing device 10 in FIG. 3 is used. What differs in Embodiment 2 are as follows: the directions pointing from any point in areas 3C, 3L, 3R, 3SL, and 3SR to origin O are handled as a first, a second, a third, a fourth, and a fifth direction respectively; by use of directivity control in the sound source separator 11, sound signals in which the sounds from sound sources located in areas 3C, 3L, 3R, 3SL, and 3SR are emphasized are generated as a first, a second, a third, a fourth, and a fifth unit sound signal respectively.

As a result, the target sound signals (see FIG. 4) are multiple-channel signals, more specifically a five-channel signal, composed of a first unit sound signal (center signal) in which the signal component of a sound from in front (from the front direction) is emphasized, a second unit sound signal (left signal) in which the signal component of a sound from obliquely front-left is emphasized, a third unit sound signal (right signal) in which the signal component of a sound from obliquely front-right is emphasized, a fourth unit sound signal (surround left signal) in which the signal component of a sound from obliquely rear-left is emphasized, and a fifth unit sound signal (surround right signal) in which the signal component of a sound from obliquely rear-right is emphasized.

The volume controller 15 corrects, by the method described with regard to Embodiment 1, the signal levels of the first to fifth unit sound signals thus obtained, and thereby generates the first to fifth unit sound signals after signal level correction. These first to fifth unit sound signals after signal level correction in the form of multiple-channel signals, more specifically five-channel signals, may be recorded to a recording medium (for example, the recording medium 102 in FIG. 19), or played back and outputted from a speaker section (for example, the speaker section 146 in FIG. 19). In Embodiment 2, however, they are subjected to down-mixing so that two-channel signals may be recorded or played back.

Specifically, the first, second, and fourth unit sound signals after signal level correction are mixed in a predetermined ratio to generate a first channel signal, and the first, third, and fifth unit sound signals after signal level correction are mixed in a predetermined ratio to generate a second channel signal. More specifically, for example, the volume controller 15 performs down-mixing according to formulae (3) and (4) below. Here, x_{C}(t), x_{L}(t), x_{R}(t), x_{SL}(t), and x_{SR}(t) represents the signal values of the first, second, third, fourth, and fifth unit sound signals, respectively, after the signal level correction described above, and x₁(t) and x₂(t) represent the signal values of the first and second channel signals, respectively, obtained through the down-mixing. The mix ratio of x_{C}(t), x_{L}(t) and x_{SL}(t) in the calculation of x₁(t) may be changed (a similar description applies to x₂(t)).

x₁(t)=0.7×x_{C}(t)+x_{L}(t)+x_{SL}(t) (3)

x₂(t)=0.7×x_{C}(t)+x_{R}(t)+x_{SR}(t) (4)

The first and second channel signals form stereophonic signals. The stereophonic signals formed by the first and second channel signals are outputted, as corrected sound signals, from the volume controller 15. The sound signal processing device 10 according to Embodiment 2 also is usable as the sound signal processing device 101 or 121 (see FIGS. 17 to 19).

### Embodiment 3

Next, a third embodiment (Embodiment 3) of the invention will be described. Embodiment 3 deals with a first to a fifth applied technique (Applied Techniques 1 to 5) that may be adopted in the sound signal processing device 10 in FIG. 3, and the recording device 100, the sound signal playback device 120, and the image shooting device 140 in FIGS. 17 to 19 (these will sometimes be abbreviated to devices 10, 100, 120, and 140 respectively in the following description). Unless inconsistent, two or more of Applied Techniques 1 to 5 may be implemented in combination.

### Applied Technique 1

The device 10, 100, 120, or 140 may be so configured that whether or not to execute signal level correction (in other word, sound volume adjustment) by the volume controller 15 can be specified by manual operation. When it is specified not to execute signal level correction, the first to n-th unit sound signals generated in the sound source separator 11, or the detection signals of the microphones 1L and 1R, are, intact, recorded to a recording medium (for example, the recording medium 102 in FIG. 19), or played back and outputted from a speaker section (for example, the speaker section 146 in FIG. 19).

### Applied Technique 2

The method for signal level correction (in other word, sound volume adjustment) by the volume controller 15 may be switched between that described with regard to Embodiment 1 and another method. The user can request switching by manual operation. For example, alternative choice between a first and a second volume adjustment method is permitted, and when the first volume adjustment method is chosen, the corrected sound signals are recorded or played back through the operation described with regard to Embodiment 1.

On the other hand, when the second volume adjustment method is chosen, the volume controller 15 applies AGC or ALC to each unit sound signal. Specifically, the voltage amplitude of each unit sound signal fed from the sound source separator 11 to the volume controller 15 is corrected through signal amplification processing in such a way that the voltage amplitude of each unit sound signal outputted from the volume controller 15 is kept constant. The first to n-th unit sound signals after voltage amplitude correction by AGC or ALC also are, as sound signals forming corrected sound signals, recorded to a recording medium (for example, the recording medium 102 in FIG. 19), or played back and outputted from a speaker section (for example, the speaker section 146 in FIG. 19) (a similar description applies to Applied Techniques 3 and 4 described below).

### Applied Technique 3

The device 10, 100, 120, or 140 may be so configured that the method for signal level correction (in other words, sound volume adjustment) by the volume controller 15 can be switched between that described with regard to Embodiment 1 and another method in such a way that, with respect to a frequency band of 8 kHz or lower, which contains a main sound component, sound volume adjustment is performed by the method described with regard to Embodiment 1 to generate corrected sound signals and, with respect to a frequency band higher than 8 kHz, sound volume adjustment is performed by another method (for example, AGC or ALC).

### Applied Technique 4

The image shooting device 140 may be so configured that the method for signal level correction (in other words, sound volume adjustment) by the volume controller 15 can be switched between that described with regard to Embodiment 1 and another method in such a way that, when it is found that a person appears in an image shot by the image shooting device 140, sound volume adjustment is performed by the former method to generate corrected sound signals and, when it is found that no person appears in a shot image, sound volume adjustment is performed by the latter method (for example, AGC or ALC). The image processor 144 in FIG. 19 can check whether or not a person appears in a shot image based on the image signal of the shot image, by use of a well-known face detection processing or the like.

### Applied Technique 5

In the example described previously, the sound type detector 12 in FIG. 3 classifies the sound sources corresponding to individual unit sound signals into four types, namely, “human voice,” “music,” “noise,” and a fourth type. The number of types into which sound sources are classified may be other than four.

In a real environment, the sound signals from a plurality of sound sources of a plurality of types may reach microphones from the same direction or from mutually close directions. To cope with such cases, the sound type detector 12 may be so configured that it can recognize that the sound source corresponding to an i-th unit sound signal is a mixed sound source of two or more types of sound sources.

For example, one possible configuration is as follows. By the method described with regard to Embodiment 1, the self-correlation of the i-th unit sound signal in the frequency domain is found, and thereby whether or not the sound source corresponding to the i-th unit sound signal contains a human voice is checked; moreover, the self-correlation of the i-th unit sound signal in the time domain is found, and thereby whether or not the sound source corresponding to the i-th unit sound signal contains music is checked; in this way, whether or not the sound source corresponding to the i-th unit sound signal is a mixed sound source of a human voice and music is checked. Furthermore, it is also possible to detect, based on the intensity relationship between the self-correlation in the frequency domain and the self-correlation in the time domain, the proportions of the sound volume of a human voice and the sound volume of music in the total sound volume of a mixed sound source. The volume control amount setter 14 may determine the amounts of amplification with regard to individual unit sound signals with consideration given also to whether or not the sound source corresponding to an i-th unit sound signal is a mixed sound source and to the just-mentioned sound volume proportions detected with regard to a mixed sound source.

### Embodiment 4

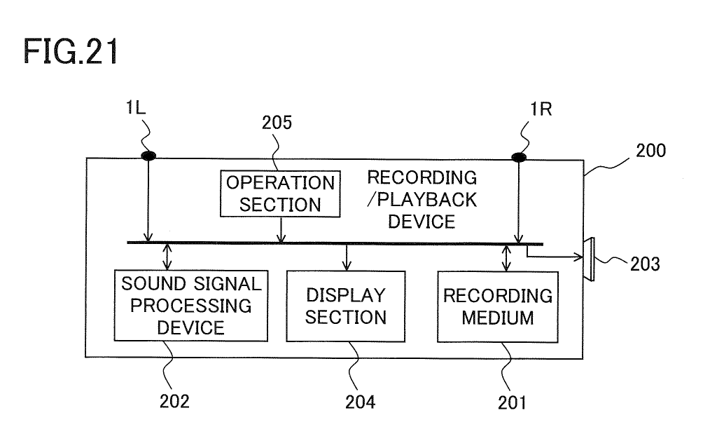

Next, a fourth embodiment (Embodiment 4) of the invention will be described. FIG. 21 shows a schematic configuration diagram of a recording/playback device 200 according to Embodiment 4. The recording/playback device 200 functions as a recording device when recording a sound signal, and functions as a playback device when playing back a sound signal. Accordingly, the recording/playback device 200 may be understood as a recording device or a playback device. The recording/playback device 200 may be additionally provided with the image sensor 143 and the image processor 144 in FIG. 19, and the recording/playback device 200 so expanded may be said to be an image shooting device.

The recording/playback device 200 is provided with microphones 1L and 1R disposed at different positions on a body of the recording/playback device 200, a recording medium 201 such as a magnetic disk or memory card, a sound signal processing device 202, a speaker section 203, a display section 204 comprising a liquid crystal display or the like, and an operation section 205 functioning as an operation receiver.

The microphones 1L and 1R are similar to those described with regard to Embodiment 1, and the positional relationship of origin O and the microphones 1L and 1R also is similar to that described with regard to Embodiment 1 (see FIG. 1). Recorded as recorded sound signals to the recording medium 201 are either original signals L and R obtained through digital conversion of the detection signals of the microphones 1L and 1R, or compressed signals of those signals.

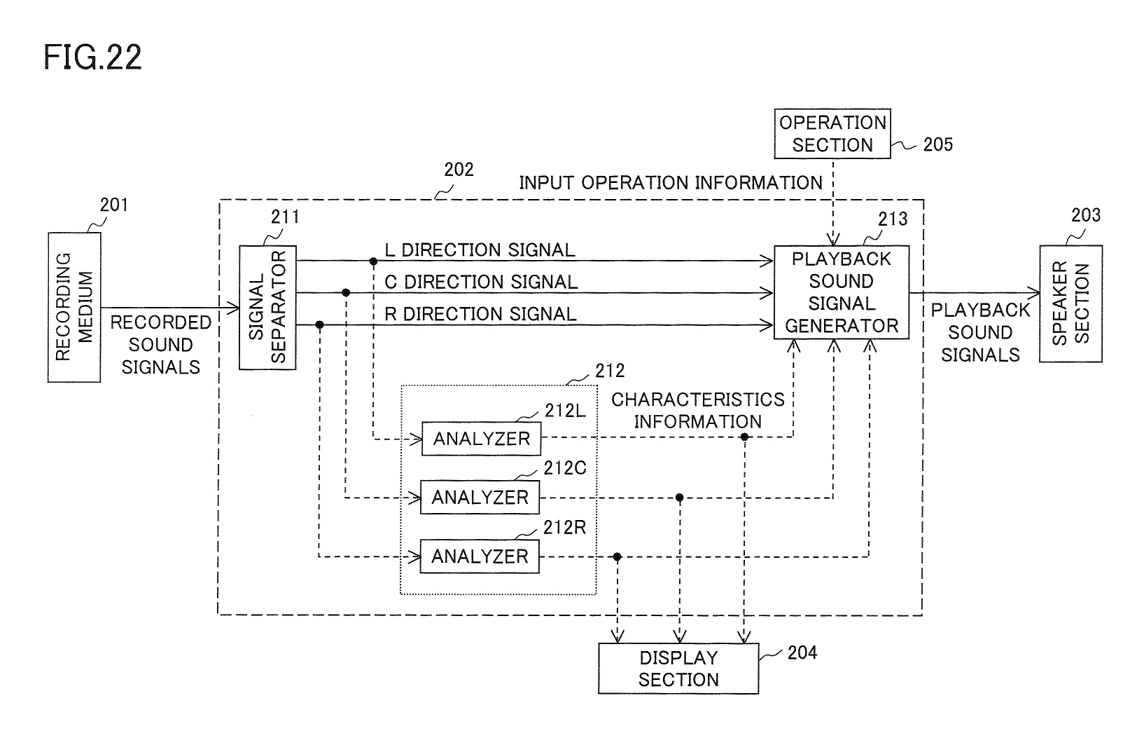

FIG. 22 is a part block diagram of the recording/playback device 200, including an internal block diagram of the sound signal processing device 202. The sound signal processing device 202 is provided with a signal separator 211, a sound characteristics analyzer 212, and a playback sound signal generator (signal processor) 213.

The signal separator 211 generates a first to an m-th direction signal based on recorded sound signals from the recording medium 201. Here, m is an integer of 2 or more. Each direction signal is a sound signal having directivity extracted from the recorded sound signals and, let i and j be different integers, then the direction of directivity differs between the i-th and j-th direction signals. In this embodiment, unless otherwise stated, it is assumed that m=3. Needless to say, m may be other than 3. Suppose now that an L direction signal, a C direction signal, and an R direction signal are generated as the first, second, and third direction signals respectively.

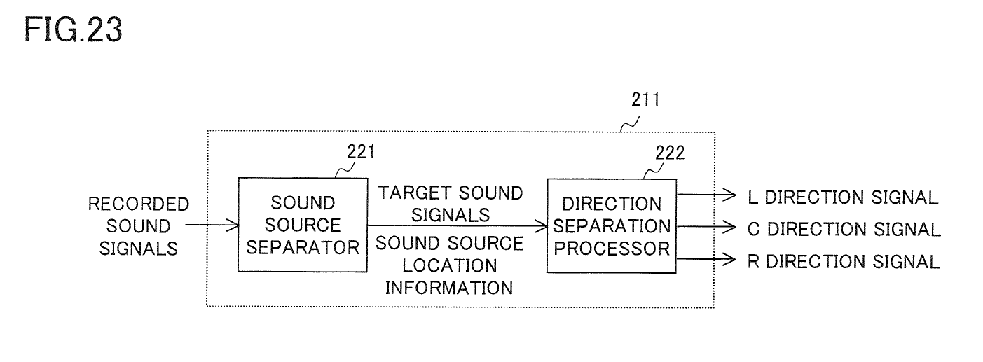

FIG. 23 is an internal block diagram of the signal separator 211. The signal separator 211 is provided with a sound source separator 221 and a direction separation processor 222. The sound source separator 221 generates and outputs sound signals that are obtained by collecting the sounds from a plurality of sound sources located at discrete positions in space and separating and extracting, one from the others, the signals from the individual sound sources. Usable as the sound source separator 221 here is the sound source separator 11 in FIG. 3. In this embodiment, it is assumed that the sound source separator 221 is the same as the sound source separator 11. Accordingly, the sound signals outputted form the sound source separator 221 are target sound signals as described with regard to Embodiment 1. As described with regard to Embodiment 1, the target sound signals are sound signals including a first unit sound signal representing the sound from a first sound source, a second unit sound signal representing the sound from a second sound source, . . . , a (n−1)-th unit sound signal representing the sound from an (n−1)-th sound source, and an n-th unit sound signal representing the sound from an n-th sound source (where, as described previously, n is an integer of 2 or more). The first to n-th unit sound signals are, as the sound signals of the first to n-th sound sources respectively, outputted from the sound source separator 221. An i-th unit sound signal is a sound signal that reaches the recording/playback device 200 (more specifically, origin O on the recording/playback device 200) from an i-th direction (where i is an integer). The significance of an i-th direction, which may be said to be an i-th origination direction, is as described with regard to Embodiment 1.

Through directivity control described with regard to Embodiment 1, the sound source separator 221 can separate and extract the individual unit sound signals from the recorded sound signals. Furthermore, as in Embodiment 1, sound source location information representing the first to n-th directions, or representing the locations of the first to n-th sound sources, is added to the first to n-th unit sound signals outputted from the sound source separator 221.

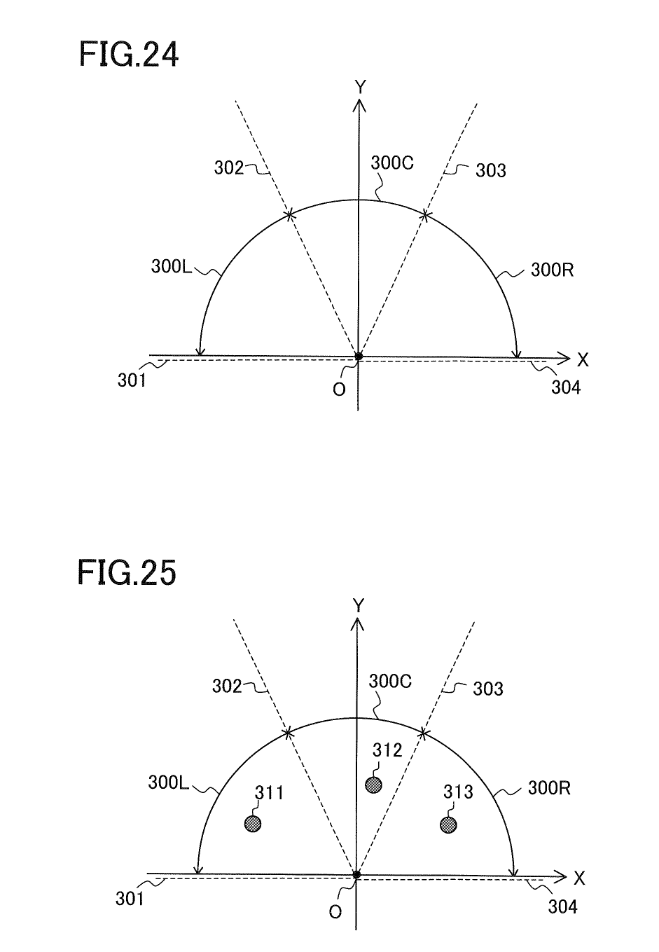

Based on the sound source location information, the direction separation processor 222 separates and extracts the L, C, and R direction signals from the target sound signals. How this separation is performed will now be described. As shown in FIG. 24, with line segments 301 to 304 as borders, three areas 300L, 300C, and 300R are set on the XY coordinate plane. While the relationship between each of the line segments 301 to 304 and X and Y axes may be changed according to a user instruction or the like (the details will be given later), unless no such change is made, it is assumed that line segment 301 is a line segment extending from origin O in the negative direction of X axis parallel to the X axis, that line segment 304 is a line segment extending from origin O in the positive direction of X axis parallel to the X axis, that line segment 302 is a line segment extending from origin O into the second quadrant on the XY coordinate plane, and that line segment 303 is a line segment extending from origin O into the first quadrant on the XY coordinate plane. In this case, line segments 301 and 304 are actually line segments on X axis, but, for the sake of convenience of illustration, in FIG. 24, line segments 301 and 304 are shown slightly apart from X axis (a similar description applies to FIG. 25 etc. described later). For example, line segment 302 is inclined 30 degrees counter-clockwise relative to Y axis, and line segment 303 is inclined 30 degrees clockwise relative to Y axis. Area 300L is a part, lying between line segments 301 and 302, of the second quadrant on the XY coordinate plane, area 300C is a part, lying between line segments 302 and 303, of the first and second quadrants on the XY coordinate plane, and 300R is a part, lying between line segments 303 and 304, of the first quadrant on the XY coordinate plane.

Based on the sound source location information, the direction separation processor 222 distributes the first unit sound signal into one of L, C, and R direction signals. Specifically, if the origination direction of the first unit sound signal, that is, the first direction corresponding to the first unit sound signal, is a direction pointing from a position in area 300L to origin O, the first unit sound signal is distributed into the L direction signal; if the first direction is a direction pointing from a position in area 300C to origin O, the first unit sound signal is distributed into the C direction signal; if the first direction is a direction pointing from a position in area 300R to origin O, the first unit sound signal is distributed into the R direction signal. Similar operation is performed with respect to the second to n-th unit sound signals. In this way, each unit sound signal is distributed into one of the L, C, and R direction signals.

For example, in a case where, as shown in FIG. 25, n=3 and where a sound source 311 as the first sound source, a sound source 312 as the second sound source, and a sound source 313 as the third sound source are located in areas 300L, 300C, and 300R respectively, then the L, C, and R direction signals will be the first, second, and third unit sound signals respectively. A case where a plurality of sound sources are located in one area is dealt with likewise. Specifically, for example, in a case where n=6, where the first, second, and third sound sources are located in area 300L, where the fourth and fifth sound sources are located in area 300C, and where the sixth sound source is located in area 300R, then the L direction signal will be a composite signal of the first, second, and third unit sound signals, the C direction signal will be a composite signal of the fourth and fifth unit sound signals, and the R direction signal will be the sixth unit sound signal.

As will be understood from the foregoing, the L direction signal is the sound signal from the sound source located in area 300L as extracted from the target sound signals. The L direction signal may be said to be a sound signal that originated from a position in area 300L. A similar description applies to the C and R direction signals. In the following description, for the sake of convenience of description, a direction pointing from any position in area 300L to origin O will be called L direction, a direction pointing from any position in area 300C to origin O will be called C direction, and a direction pointing from any position in area 300R to origin O will be called R direction.

In the example under discussion, the L, C, and R direction signals are generated through generation of unit sound signals; instead, generation of unit sound signals may be omitted, and the L, C, and R direction signals may be extracted directly, through directivity control, from recorded sound signal as input sound signals, that is, from the detection signals of a plurality of microphones. Of the target sound signals or the recorded sound signals, any signal component of which the sound origination direction—the direction from which the sound it conveys originates—is L direction is an L direction signal (a similar description applies to C and R direction signals).

The sound characteristics analyzer 212 in FIG. 22 is composed of analyzers 212L, 212C, and 212R and, by analyzing the target sound signals for each sound origination direction (in other words, by analyzing the recorded sound signals), generates, for each sound origination direction, characteristics information representing the characteristics of the sound. The sound signal processing device 202 classifies sound origination directions into L, C, and R directions, and extracts L, C, and R direction signals as the signal components in L, C, and R directions. Thus, the analyzers 212L, 212C, and 212R each analyze the corresponding one of the L, C, and R direction signals individually. The analyzer 212L analyzes, based on the L direction signal, the characteristics of the sound the L direction signal conveys and generates L characteristics information representing the characteristics of that sound. Likewise, the analyzer 212C analyzes, based on the C direction signal, the characteristics of the sound the C direction signal conveys and generates C characteristics information representing the characteristics of that sound, and the analyzer 212R analyzes, based on the R direction signal, the characteristics of the sound the R direction signal conveys and generates R characteristics information representing the characteristics of that sound.

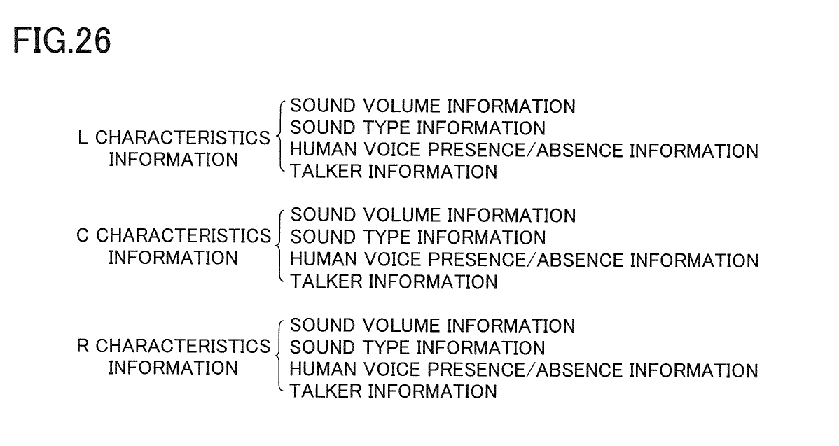

FIG. 26 shows the structures of the L, C, and R characteristics information. The structure of the L characteristics information is the same as the structure of each of the C and R characteristics information, and the operation of the analyzer 212L is the same as the operation of each of the analyzers 212C and 212R. Accordingly, the operation of the analyzer 212L, as representative of the analyzers 212L, 212C, and 212R, will be described below.

The analyzer 212L integrates sound volume information representing the sound volume of the sound the L direction signal conveys into the L characteristics information. The sound volume of the sound the L direction signal conveys increases as the signal level of the L direction signal increases; thus, by detecting the signal level of the L direction signal, the sound volume in question is detected, and sound volume information is generated. It should be understood that the term “sound volume of a sound” here is synonymous with the term “sound volume of a sound source” used in the description of Embodiment 1.

The analyzer 212L integrates sound type information representing the type of the sound the L direction signal conveys into the L characteristics information. It should be understood that the term “type of a sound” here is synonymous with the term “type of a sound source” used in the description of Embodiment 1. The type of a sound will sometimes be called simply a sound type. Based on the L direction signal, the analyzer 212L discriminates the type of the sound the L direction signal conveys (in other words, the type of the sound source of the L direction signal). Usable as a method for this discrimination is, for example, that used by the sound type detector 12 in FIG. 3. Accordingly, the analyzer 212L can classify the type of the sound source of the L direction signal into one of “human voice,” “music,” and “noise,” and can thus integrate the result of the classification into the sound type information. In a case where the L direction signal is a composite signal of a plurality of unit sound signals, it is preferable to discriminate, for each unit sound signal, the sound source of the unit sound signal. In that case, the L characteristics information in a given span contains sound type information related to a plurality of sound sources.

Based on the L direction signal, the analyzer 212L checks whether or not the sound the L direction signal conveys contains a human voice, and incorporates human voice presence/absence information indicating the result of the detection into the L characteristics information. Since the type of the sound source of the L direction signal has been analyzed in the above-described process of generating sound type information, the result of the analysis can be used to generate human voice presence/absence information.

If the sound the L direction signal conveys contains a human voice, then, based on the L direction signal, the analyzer 212L detects the person (hereinafter the talker) who uttered the voice, and incorporates talker information representing the detected talker into the L characteristics information. The detection of the talker by the analyzer 212L is accomplished when the person uttering the voice conveyed by the L direction signal is a previously registered person (hereinafter a registered person). There may be only one registered person, but it is here assumed that there are two different—a first and a second—registered persons. The user can previously record sound signals of the voices of those registered persons to a registered person memory (unillustrated) provided in the recording/playback device 200. The analyzer 212L analyses the characteristics of the voices of the individual registered persons by use of the registered person memory, and generates the talker information by use of the result of the analysis. Usable as an analysis technique for generating the talker information here is any well-known talker recognition technology.

The playback sound signal generator 213 in FIG. 22 generates playback sound signals from the L, C, and R direction signals. The playback sound signals are fed to a speaker section 203, which comprises one speaker or a plurality of speakers, so as to be played back as sounds. While the details will be given later, the method for generating the playback sound signals from the L, C, and R direction signals is determined based on the characteristics information from the sound characteristics analyzer 212 and/or input operation information from the operation section 205. The user can operate the operation section 205, which comprises switches etc., in various ways (hereinafter referred to as input operation) so that through input operation he may feed desired instructions into the recording/playback device 200. Input operation information is information representing the contents of input operation. In this embodiment, and also in Embodiment 5 described later, it is assumed that the display section 204 is provided with so-called touch-panel capabilities. Accordingly, part or all of input operation is achieved as touch-panel operation on the display section 204.

### Display of Characteristics Information

The recording/playback device 200 is provided with a unique capability, namely a capability of displaying characteristics information. The user can, while consulting characteristics information so displayed, perform input operation. How characteristics information is displayed on the display section 204 will now be described. In this embodiment, and also in Embodiment 5 described later, display refers to that on the display section 204 unless otherwise stated. Accordingly, for example, what is simply referred to as a display screen denotes a display screen on the display section 204.

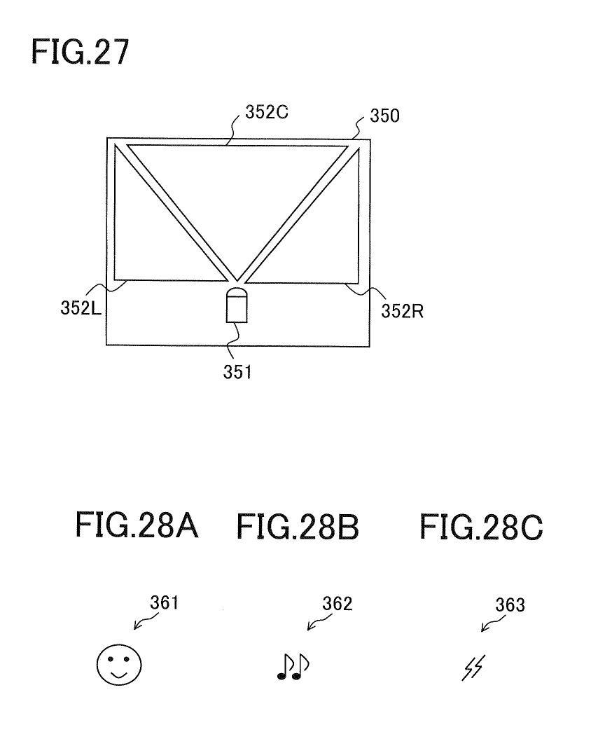

First, with reference to FIG. 27, an image 350 that serves as a basis will be described. The image 350 comprises an icon 351 symbolizing a speaker and area icons 352L, 352C, and 352R symbolizing areas 300L, 300C, and 300R. In the example shown in FIG. 27, the area icons 352L, 352C, and 352R each have a triangular shape. On the image 350, a two-dimensional coordinate plane like the XY coordinate plane in FIG. 24 is defined. On the image 350, at a position corresponding to origin O, the icon 351 is arranged and, at positions corresponding to areas 300L, 300C, and 300R, the area icons 352L, 352C, and 352R are arranged respectively.

The display section 204 displays the image 350 including the icons 351, 352L, 352C, and 352R, and in addition displays, according to characteristics information, a sound source icon in a form superimposed on the image 350. As shown in FIGS. 28A to 28C, an sound source icon may be a person icon 361 which indicates that the sound source is a human voice, or a music icon 362 which indicates that the sound source is music, or a noise icon 363 which indicates that the sound source is noise.

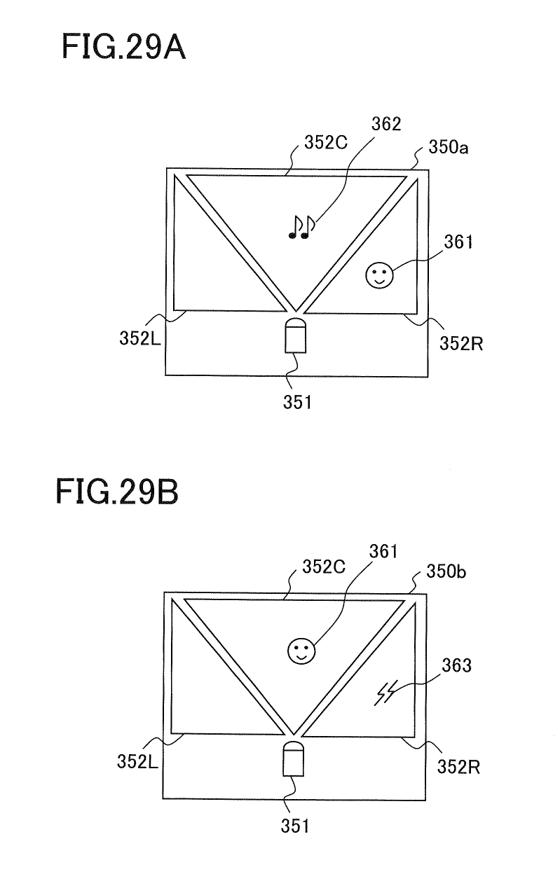

Accordingly, for example, when the characteristics information indicates that the sound source of the C direction signal is music and that the sound source of the R direction signal is a human voice, an image 350a as shown in FIG. 29A is displayed. The image 350a has a music icon 362 and a person icon 361 superimposed on the image 350 and, on the image 350a, the music icon 362 and the person icon 361 are arranged within the area icon 352C and within the area icon 352R respectively. For another example, when the characteristics information indicates that the sound source of the C direction signal is a person and that the sound source of the R direction signal is noise, an image 350b as shown in FIG. 29B is displayed. The image 350b has a person icon 361 and a noise icon 363 superimposed on the image 350 and, on the image 350b, the person icon 361 and the noise icon 363 are arranged within the area icon 352C and within the area icon 352R respectively. A case where a sound source is located in L direction is dealt with likewise. In the following description, the image 350a in FIG. 29A will be referred to as representative of images that indicate the sound types in different directions.

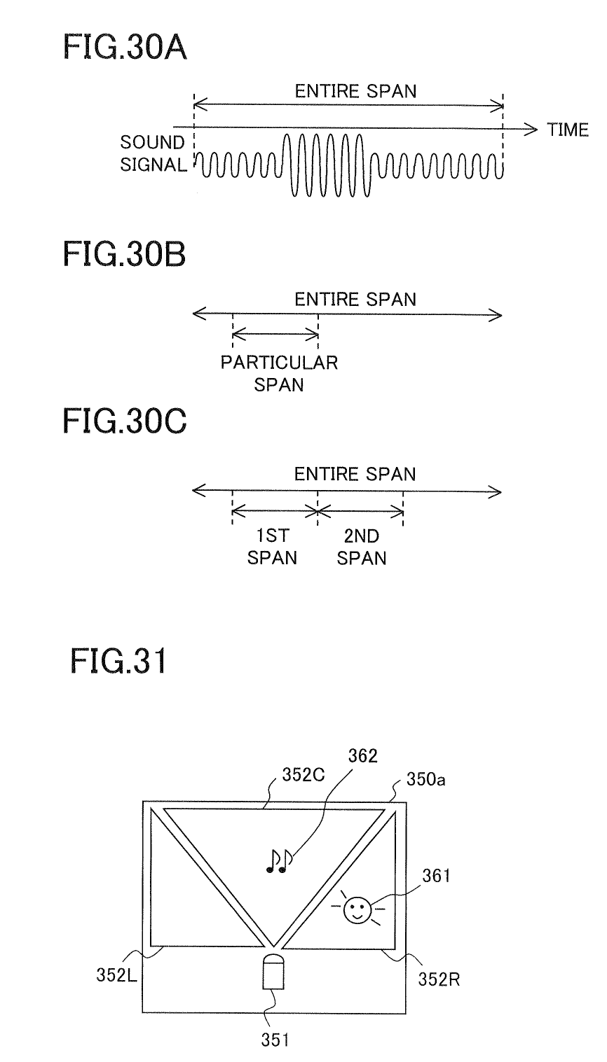

In the following description, as shown in FIG. 30A, the whole span (time span) over which a given sound signal is present will be called an entire span. The length in time of the entire span of recorded sound signals is equal to the length of the recording time of the recorded sound signals. The length in time of the entire span of sound signals (the target sound signals and the L, C, and R direction signals) generated from recorded sound signals is equal to that of the recorded sound signals. Moreover, in the following description, part of an entire span is sometimes called a particular span, a first span, or a second span (see FIGS. 30B and 30C). It is here assumed that a first and a second span are different spans, and that the second span occurs after the first span. For example, as shown in FIG. 30C, a first and a second span are consecutive spans.

Characteristics information can be displayed on a real-time basis during playback of the playback sound signals corresponding to the characteristics information. This is called real-time display of characteristics information. In real-time display of characteristics information, while playback sound signals based on the L, C, and R direction signals in a particular span are being played back on the speaker section 203, characteristics information based on the L, C, and R direction signals in the particular span is displayed on the display section 204. In this case, for example, if the playback sound signals based on the L, C, and R direction signals in the particular span include the C and R direction signals in the particular span, and in addition the sound sources of the C and R direction signals in the particular span are music and a human voice respectively, then, while the playback sound signals based on the L, C, and R direction signals in the particular span are played back on the speaker section 203, the image 350a in FIG. 29A is displayed. Furthermore, whenever the human voice conveyed by the R direction signal is actually being outputted from the speaker section 203, the user may be informed of its output by a talk indication. For example, whenever that occurs, as shown in FIG. 31, the person icon 361 on the image 350a, or the area icon 352R in which the person icon 361 is arranged, may be blinked.

Instead, before playback sound signals based on recorded sound signals are actually played back on the speaker section 203, characteristics information may be generated from the recorded sound signals to be displayed on the display section 204. This is called prior display of characteristics information. For prior display of characteristics information, prior to generation of playback sound signals, recorded sound signals are read from the recording medium 201 to generate characteristics information. Here, the analysis span for generation of characteristics information may be an entire span, or a limited partial span out of the entire span. In prior display of characteristics information, characteristics information based on the recorded sound signals in the analysis span is displayed on the display section 204.

Instead, for prior display of characteristics information, it is also possible to extract representative sound signals direction by direction and output them from the speaker section 203 prior to playback of playback sound signals. Specifically, of the L direction signal during the analysis span, a sound signal conveying a human voice is extracted as the representative sound signal in L direction. Or, of the L direction signal during the analysis span, the L direction signal in a span in which it has the highest volume is extracted as the representative sound signal in L direction. Or, of the L direction signal during the entire span, the sound signal of the first sound to occur is extracted as the representative sound signal in L direction. Then, while prior display of characteristics information is being performed, according to a user instruction, or irrespective of whether or not a user instruction is entered, the representative sound signal in L direction may be outputted from the speaker section 203. A similar description applies to C and R directions.

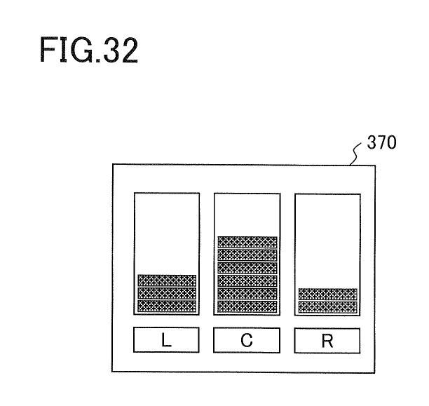

It is also possible to generate and display an image 370 as shown in FIG. 32 that indicates the sound volumes of the L, C, and R direction signals individually based on sound volume information contained in characteristics information. Since the sound volumes in the individual directions vary constantly, the image 370 is displayed in real-time display of characteristics information. The image 370 may be displayed alone on the display section 204, or may be displayed simultaneously with the image 350a in FIG. 29A. The recording/playback device 200 may be provided with LEDs (light-emitting diodes, unillustrated) for L, C, and R directions which light in a plurality of colors, and these LEDs may be lit in different colors according to characteristics information thereby to notify the user of the sound volumes direction by direction. In this case, the color in which to light the LED for L direction is determined according to sound volume information in L characteristics information. A similar description applies to C and R directions.

While the image 350a in FIG. 29A indicates sound types direction by direction, and the image 370 in FIG. 32 indicates sound volumes direction by direction, human voice presence/absence information and talker information (see FIG. 26) with respect to L, C, and R characteristics information may also be displayed separately from the image 350a and/or 370, or on the image 350a and/or 370. Here, it may be said that human voice presence/absence information is already shown on the image 350a in FIG. 29A. Talker information may be displayed in a form superimposed on the image 350a in FIG. 29. Specifically, for example, while the image 350a in FIG. 29A is being displayed, in a case where R characteristics information indicates that a human voice as the sound source of the R direction signal is a first registered person, the name or the like of the first registered person may be displayed in a superimposed form within the area icon 352R in the image 350a.

It should be understood that, although the above description deals with a few image configurations for indicating sound volumes, sound types, etc. to the user, they are merely examples, and that those image configurations may therefore be modified in many ways so long as they can inform the user of direction-by-direction characteristics information. It should also be understood that, although the above description deals with methods for notifying the user of characteristics information visually by means of image display and LEDs (that is, methods employing the display section 204 or LEDs as a notifier), any method for notifying of characteristics information may be used so long as it can inform the user of direction-by-direction characteristics information.

### Generating Playback Sound Signals According to Input Operation Information

Next, a method for generating playback sound signals according to input operation information will be described. The user can perform, on the operation section 205, direction specification operation to specify, out of a first to an m-th direction (in other words, a first to an m-th origination direction), one or more but m or less directions. Input operation at least includes direction specification operation. A direction specified by direction specification operation is called a specified direction (or specified origination direction). In the example under discussion in this embodiment, m=3, and the first to m-th directions comprise L, C, and R directions. For example, while the image 350a in FIG. 29A is displayed, the user can, by specifying the person icon 361 or the area icon 352R on the image 350a by touch-panel operation, specify R direction as a specified direction, and can, by specifying the music icon 362 or the area icon 352C on the image 350a by touch-panel operation, specify C direction as a specified direction (a similar description applies to L direction). The user can specify a specified direction by operation other than touch-panel operation. For example, in a case where the operation section 205 is provided with a four-way key (unillustrated), a joy stick, or the like, this can be used to specify a specified direction.

The playback sound signal generator 213 can output recorded sound signals or target sound signals intact as playback sound signals, and can also generate playback sound signals as described below by applying signal processing according to input operation by the user to target sound signals composed of L, C, and R direction signals. Presented below as examples of such signal processing will be first to third signal processing (Signal Processing 1 to 3).

Signal Processing 1: Signal Processing 1 will now be described. In Signal Processing 1, a playback sound signal is generated by extracting a signal component in a specified direction from target sound signals composed of L, C, and R direction signals. Signal Processing 1 functions effectively when the number of specified directions is (m−1) or less (that is, 1 or 2).

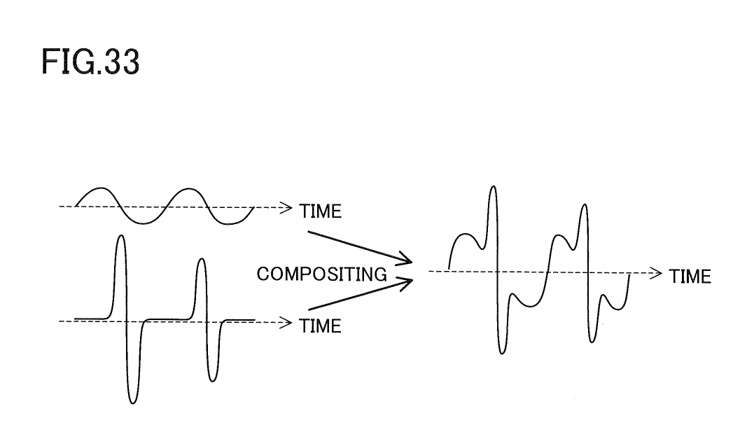

For example, in a case where C direction alone has been specified by direction specification operation, out of the L, C, and R direction signals, the C direction signal alone is selected, so that the C direction signal is taken as a playback sound signal. A similar description applies in cases where L or R direction alone has been specified. For another example, in a case where C and R directions have been specified by direction specification operation, out of the L, C, and R direction signals, the C and R direction signals are selected, and a composite signal of the C and R direction signals is generated as a playback sound signal. Signal compositing for generation of a playback sound signal is achieved, as shown in FIG. 33, by adding up a plurality of sound signals as targets of compositing in a common span.

By use of Signal Processing 1, the user can, while consulting what is displayed as characteristics information, specify a desired direction and listen to the sound from the desired direction alone.

Signal Processing 2: Signal Processing 2 will now be described. In Signal Processing 2, a playback sound signal is generated by applying processing for emphasizing or attenuating a signal component in a specified direction to target sound signals composed of L, C, and R direction signals. Signal Processing 2 functions effectively when the number of specified directions is m or less (that is, 1, 2, or 3).

For example, the user can specify C direction as a specified direction and then specify, by input operation, amplification or attenuation of the C direction signal. Here, the user can freely specify, by input operation, also the degree of amplification or attenuation. Amplifying the C direction signal means increasing the signal level of the C direction signal, and attenuating the C direction signal means reducing the signal level of the C direction signal. Naturally, when the C direction signal is amplified, the signal component in C direction is emphasized, and when the C direction signal is attenuated, the signal component in C direction is attenuated. After receiving input operation specifying amplification or attenuation of the C direction signal, the playback sound signal generator 213 generates as a playback sound signal a composite signal of the L and R direction signals fed from the signal separator 211 and the amplified or attenuated C direction signal. While the description has dealt with how a playback sound signal is generated in a case where C direction is specified as a specified direction, a similar description applies in cases where L or R direction is specified as a specified direction.

The user can specify two or more of L, C, and R directions as specified directions, and specify, by input operation, for each of the specified directions, amplification or attenuation of the direction signal corresponding to that specified direction. For example, when input operation specifying amplification of the C direction signal and attenuation of the R direction signal is performed on the operation section 205, after the input operation, the playback sound signal generator 213 generates as a playback sound signal a composite signal of the L direction signal fed from the signal separator 211, the amplified C direction signal, and the attenuated R direction signal.

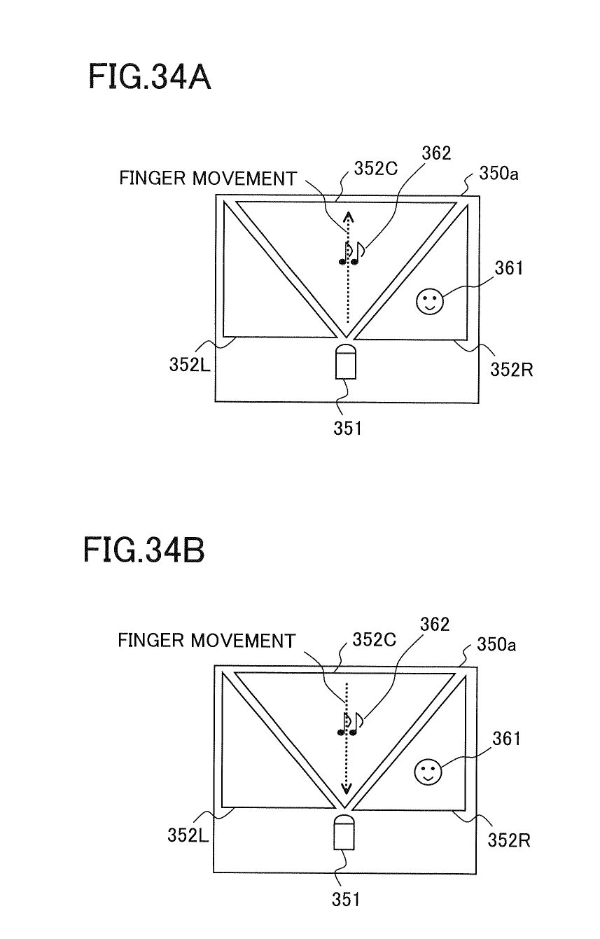

While the image 370 in FIG. 32 indicating direction-by-direction sound volume information is being displayed, the user can, by performing predetermined touch-panel operation in the part on the display screen corresponding to C direction, specify C direction as a specified direction, and can also specify amplification or attenuation of the C direction signal, and even the degree of amplification or attenuation. Also while the image 350a in FIG. 29A is being displayed, amplification of a signal etc. can be specified by touch-panel operation. For example, while the image 350a in FIG. 29A is being displayed, as shown in FIG. 34A, the user can put a finger at the border between the icon 351 and the area icon 352C and slide it across the display screen away from the icon 351 within the area icon 352C; in this way, amplification of the C direction signal is specified, and the specified amplification is effected. By contrast, when, as shown in FIG. 34B, the user moves a finger, as compared with what has just been described, in the opposite direction, attenuation of the C direction signal is specified, and the specified attenuation is effected.

By use of Signal Processing 2, the user can, while consulting what is displayed as characteristics information, specify a desired direction and listen to the recorded sounds with the sound from the desired direction emphasized or attenuated.

Signal Processing 3: Signal Processing 3 will now be described. In Signal Processing 3, a playback sound signal is generated by mixing signal components in different directions in a desired mix ratio.

Signal Processing 3 can be said to be equivalent to Signal Processing 2 as performed when the number of specified directions is three. The user can, by input operation, for each direction signal, specify whether to amplify or attenuate that direction signal and the degree of amplification or attenuation of the direction signal. The specifying methods here may be similar to those in Signal Processing 2.

According to what is specified, the playback sound signal generator 213 generates a playback sound signal by compositing the amplified or attenuated L, C, and R direction signals. Depending on the contents of input operation, however, no amplification or attenuation may be performed on one or two of the L, C, and R direction signals.

The user may want to listen to the sound signal from a particular sound source (for example, a sound signal related to a first registered person, or a sound signal having the highest or lowest sound volume) in an extracted or emphasized form, or may want to listen to playback sound signals in which the sound volumes in all directions are equal. By use of Signal Processing 1 to 3, it is possible to cope with all those requirements.

In a case where prescribed characteristics information is previously recorded in the sound signal processing device 202, the playback sound signal generator 213 may, irrespective of input operation, automatically select a specified direction based on the prescribed characteristics information and on characteristics information, and perform Signal Processing 1 or 2. In the prescribed characteristics information, there is defined at least one of sound volume information, sound type information, human voice presence/absence information, and talker information. The playback sound signal generator 213 selects, when the prescribed characteristics information agrees with L characteristics information, L direction as a specified direction, selects, when the prescribed characteristics information agrees with C characteristics information, C direction as a specified direction, and selects, when the prescribed characteristics information agrees with R characteristics information, R direction as a specified direction.

The user can previously set prescribed characteristics information via the operation section 205, and can previously set what signal processing to perform in the playback sound signal generator 213 with respect to the direction signal of a direction specified according to the prescribed characteristics information.

For example, it is possible to define, in prescribed characteristics information, sound type information stating that the sound type is “human voice.” In this case, when C characteristics information indicates that the sound type of the C direction signal is “human voice,” the prescribed characteristics information agrees with the C characteristics information; thus, C direction is selected as a specified direction, and Signal Processing 1 is performed. Specifically, the C direction signal is taken as a playback sound signal. Or, C direction is selected as a specified direction, and Signal Processing 2 is performed. Specifically, for example, a composite signal of the L and R direction signals fed from the signal separator 211 and the amplified or attenuated C direction signal is generated as a playback sound signal. The degree of amplification or attenuation can also be previously set by the user. A similar description applies in cases where the prescribed characteristics information agrees with L or R characteristics information.

### Area Change Operation

The user can, by prescribed operation (including touch-panel operation) on the operation section 205, change the directions, and the breadth of those direction, corresponding to areas 300L, 300C, and 300R (see FIG. 24). Changing these changes the sound origination directions corresponding to areas 300L, 300C, and 300R. Operation for making a change related to areas 300L, 300C, and 300R is especially called area change operation. Area change operation may be considered to be included in input operation.

As shown in FIG. 24, area 300L is an area lying between line segments 301 and 302; thus, by rotating line segments 301 and/or 302 about origin O in such a way that the angle formed between line segment 301 and/or 302 and X axis changes, it is possible to change the sound origination direction corresponding to area 300L. A similar description applies to areas 300C and 300R. That is, through area change operation, the user can rotate line segments 301 to 304 about origin O and thereby freely set the sound origination directions corresponding to areas 300L, 300C, and 300R.

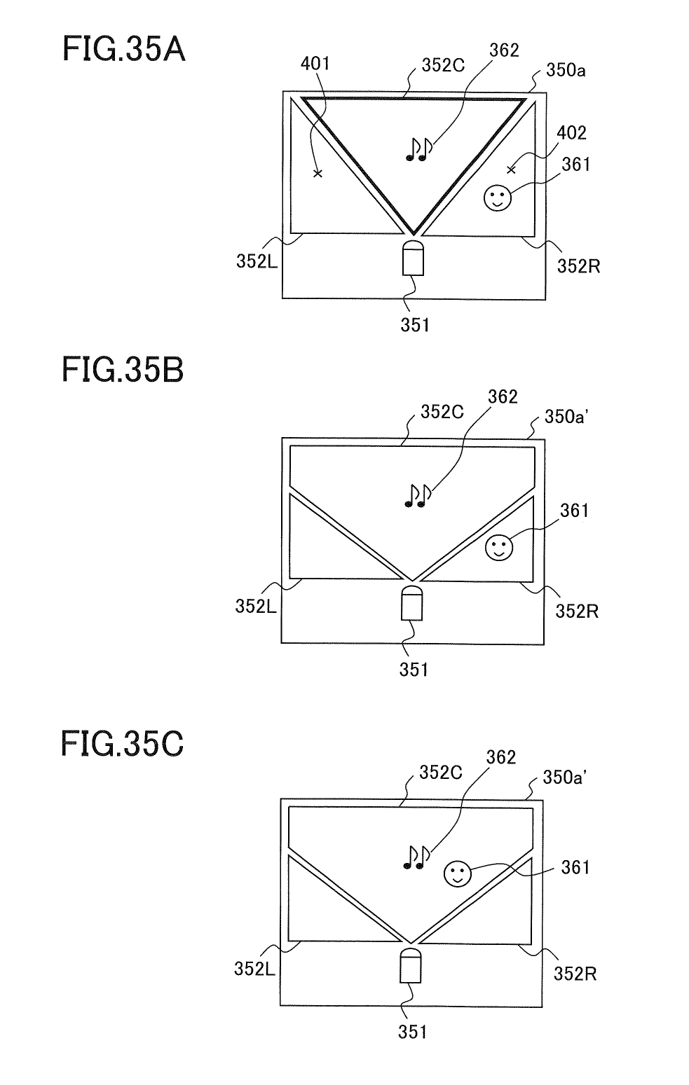

As a specific operation method for area change operation, it is possible to adopt one as described below. Consider a case where, while the image 350a in FIG. 29A is being displayed, the user performs area change operation to enlarge area 300C and reduce areas 300L and 300R. In this case, first, the user, by touch-panel operation or the like, selects the area icon 352C. This causes, as shown in FIG. 35A, the area icon 352C, which is triangular in shape, is displayed highlighted. While the area icon 352C is being selected, a press with two fingers is applied at a point 401 located on the area icon 352L side of the border between the area icons 352C and 352L and at a point 402 located on the area icon 352R side of the border between the area icons 352C and 352R.

The contents of this area change operation with fingers is transmitted to the direction separation processor 222 in FIG. 23, and according to the area change operation, the direction separation processor 222 rotates line segments 302 and 303 in FIG. 24 about origin O. Specifically, line segment 302 is so changed as to become a line segment extending from origin O in a direction corresponding to point 401, and line segment 303 is so changed as to become a line segment extending from origin O in a direction corresponding to point 402. As a result of line segments 302 and 303 being changed in this way, area 300C is changed to be larger, and areas 300L and 300R are changed to be smaller. Furthermore, as areas 300L, 300C, and 300R are so changed, according to how they are changed, on the display screen, the display section 204 changes the area icon 352C to make it larger and changes the area icons 352L and 352R to make them smaller. With these changes made, the image on the display screen changes from the 350a in FIG. 35A to the image 350a′ in FIG. 35B. As a result of area 300C being enlarged as described above, the sound signal of a human voice that belonged to the L direction signal before the change may come to belong to the C direction signal. In that case, the person icon 361, which was displayed within the area icon 352R before the change, comes to be displayed, as shown in FIG. 35C, within the area icon 352C after the change.

In a case where the speaker section 203 comprises a plurality of speakers, the user can, by predetermined operation on the operation section 205, specify the direction of the sound played back from each speaker. For example, in a case where the speaker section 203 comprises a left and a right speaker, if, for the sake of discussion, the user via the operation section 205 specifies that the sound in L direction be played back from the left speaker and that the sound in R direction be played back from the right speaker, according to the specification the playback sound signal generator 213 selects the L direction signal as a playback sound signal for the left speaker and feeds the L direction signal to the left speaker to play back the L direction signal on the left speaker and selects the R direction signal as a playback sound signal for the right speaker and feeds the R direction signal to the right speaker to play back the R direction signal on the right speaker. Here, it is also possible to perform area change operation in such a way that the sound from the direction of 90 degrees left is played back on the left speaker and the sound from the direction of 90 degrees right is played back on the right speaker

It is also possible to play back sounds from a plurality of directions on the left speaker. A similar description applies to the right speaker. For example, if, for the sake of discussion, the user via the operation section 205 specifies that the sounds in L and C directions be played back on the left speaker, according to the specification the playback sound signal generator 213 selects the L and C direction signals as playback sound signals for the left speaker and feeds a composite signal of the L and C direction signals to the left speaker to play it back on the left speaker.

### Sound Source Tracking Function

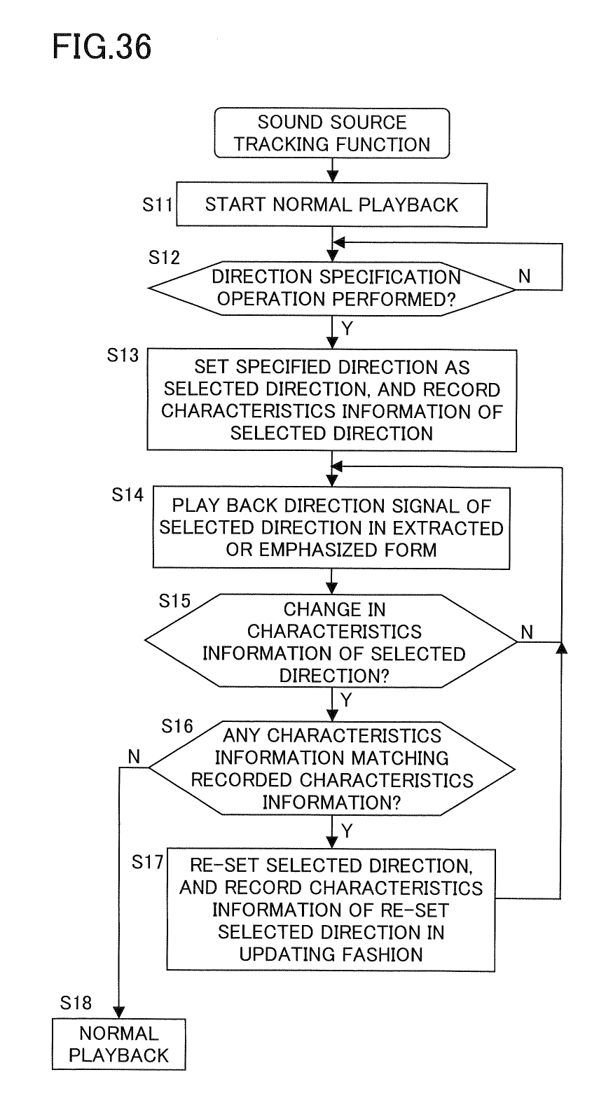

The recording/playback device 200 is provided with a capability of tracking a sound source, and the user can freely set whether or not to enable or disable the sound source tracking function. Now, with reference to FIG. 36, operation for the sound source tracking function will be described. FIG. 36 is a flow chart showing the procedure of playback operation in the recording/playback device 200 when the sound source tracking function is enabled.

First, at step S11, normal playback is started. Normal playback denotes the operation of feeding recorded sound signals (that is, a signal obtained by simply compositing the L, C, and R direction signals) as playback sound signals to the speaker section 203 for playback without performing any of signal processing 1 to 3 above. After the start of normal playback at step S11, the processing at step S12 and the following steps is performed step by step, and in parallel the playback of the playback sound signals based on the recorded sound signals proceeds.

After the start of normal playback, at step S12, the playback sound signal generator 213 checks whether or not direction specification operation has been done, and only if direction specification operation has been done, an advance is made from step S12 to step S13.

At step S13, the playback sound signal generator 213 sets the specified direction specified by the direction specification operation as a selected direction, and records characteristics information of the selected direction at the time of the direction specification operation being done to a characteristics information recording memory (unillustrated) provided in the recording/playback device 200.

After the recording at step S13, at step S14, the playback sound signal generator 213 extracts the direction signal of the selected direction from target sound signals, or emphasizes the direction signal of the selected direction, and thereby generates a playback sound signal. Specifically, taking the selected direction as a specified direction, the playback sound signal generator 213 applies Signal Processing 1 or 2 above to the target sound signals composed of the L, C, and R direction signals and thereby generates a playback sound signal. While Signal Processing 2 above can emphasize or attenuate the direction signal in a specified direction, it is here, in the sound source tracking function, assumed that it emphasizes it.

In parallel with the playback at step S14, at step S15, the playback sound signal generator 213 checks whether or not there has been a change in the characteristics information of the selected direction. Specifically, it compares the characteristics information recorded on the characteristics information recording memory (hereinafter called the recorded characteristics information) with the characteristics information of the selected direction as it currently is. If there is no change between the two sets of characteristics information, the playback at step S14 is continued; if there is a change between the two sets of characteristics information, an advance is made from step S15 to step S16.

At step S16, the playback sound signal generator 213 compares the recorded characteristics information with each of L, C, and R characteristics information as it currently is, and checks whether or not it contains any characteristics information that matches the recorded characteristics information. If it is found that there is any such characteristics information, an advance is made from step S16 to step S17. At step S17, the playback sound signal generator 213 re-sets as a selected direction the direction corresponding to the characteristics information that has been found to match the recorded characteristics information, and records, in an updating fashion, the characteristics information of the re-set selected direction to the characteristics information recording memory. That is, the recorded characteristics information is replaced with the characteristics information of the re-set selected direction. After the processing at step S17, a return is made to step S14, where the direction signal of the re-set selected direction is played back in an extracted or emphasized form.

If, at step S16, the L, C, and R characteristics information contains no characteristics information that matches the recorded characteristics information, an advance is made to step S18, where normal playback is restarted. If, in the middle of normal playback at step S18, the L, C, and R characteristics information is found to contain any characteristics information that matches the recorded characteristics information, a return may be made via the processing at step S17 to step S14. If, in the middle of normal playback at step S18, direction specification operation is done, a return may be made to step S13 to perform processing at step S13 and the following steps.

Now, assuming that R direction is specified in the direction specification operation at step S12, a specific example of the processing at step S12 and the following steps will be described.

In this case, at step S13, R direction is set as a selected direction, and the R characteristics information at the time of the direction specification operation being done is recorded to the characteristics information recording memory.

Subsequently, at step S14, the R direction signal is selected and extracted from the target sound signals composed of the L, C, and R direction signals, and the R direction signal is taken as a playback sound signal and is played back on the speaker section 203. Or, the R direction signal is amplified, and a composite signal of the L and C direction signals fed from the signal separator 211 and the amplified R direction signal is generated as a playback sound signal and is played back on the speaker section 203. The degree of amplification may be previously determined, or may be specified by the user.

In addition to the assumption that the currently selected direction is R direction, assume now further that the change and matching checked for at steps S15 and S16 with respect to characteristics information are those in sound type information, and that the sound type indicated by the recorded characteristics information is “human voice.” On these assumptions, a description will now be given of a specific example of the processing at steps S15 and S16.

When the currently selected direction is R direction, at step S15, the recorded characteristics information is compared with the R characteristics information as it currently is. Since it is now assumed that the sound type indicated by the recorded characteristics information is “human voice,” if the sound type indicated by the current R characteristics information is “human voice,” there is no difference between the compared characteristics information (that is, there is no change in the characteristics information of the selected direction), and thus a return is made from step S15 to step S14. On the other had, if the sound type indicated by the current R characteristics information is not “human voice,” it is found that there is a difference between the compared characteristics information (that is, it is found that there is a change in the characteristics information of the selected direction), and thus an advance is made from step S15 to step S16.

At step S16, the recorded characteristics information is compared with each of the L, C, and R characteristics information as it currently is.

If, for the sake of discussion, at step S16, the sound types indicated by the L, C, and R characteristics information are “noise,” “human voice,” and “noise” respectively, then the C characteristics information is found to match the recorded characteristics information; thus, subsequently, at step S17, C direction is re-set as a selected direction, and thereafter the C direction signal is played back in an extracted or emphasized form (step S14).

Or if, for the sake of discussion, at step S16, the sound types indicated by the L, C, and R characteristics information are “human voice,” “noise,” and “noise” respectively, then the L characteristics information is found to match the recorded characteristics information; thus, subsequently, at step S17, L direction is re-set as a selected direction, and thereafter the L direction signal is played back in an extracted or emphasized form (step S14).

Thus, playback is performed in such a way as to track a sound source that matches the condition of “human voice.”

Or if, at step S16, the sound types indicated by the L, C, and R characteristics information are “human voice,” “human voice,” and “noise” respectively, then the L and C characteristics information is found to match the recorded characteristics information; thus, subsequently, at step S17, L and C directions are re-set as selected directions, and thereafter the L and C direction signals are played back in an extracted or emphasized form (step S14). It should be noted here that, since basically a sound source moves continuously, it is unlikely that a sound source located in R direction at one moment is located in an area of L direction at the next moment. Accordingly, at step S16, if the sound types indicated by the L, C, and R characteristics information are “human voice,” “human voice,” and “noise” respectively, then, subsequently, at step S17, C direction alone may be re-set as a selected direction.

Next, in addition to the assumption that the currently selected direction is R direction, assume further that the change and matching checked for at steps S15 and S16 with respect to characteristics information are those in talker information, and that the talker indicated by the recorded characteristics information is a first registered person. On these assumptions, a description will now be given of a specific example of the processing at steps S15 and S16.

When the currently selected direction is R direction, at step S15, the recorded characteristics information is compared with the R characteristics information as it currently is. Since it is now assumed that the talker indicated by the recorded characteristics information is the first registered person, if the talker indicated by the current R characteristics information is the first registered person, there is no difference between the compared characteristics information (that is, there is no change in the characteristics information of the selected direction), and thus a return is made from step S15 to step S14. On the other had, if the talker indicated by the current R characteristics information is not the first registered person, it is found that there is a difference between the compared characteristics information (that is, it is found that there is a change in the characteristics information of the selected direction), and thus an advance is made from step S15 to step S16.

At step S16, the recorded characteristics information is compared with each of the L, C, and R characteristics information as it currently is.

If, for the sake of discussion, at step S16, the talkers indicated by the L, C, and R characteristics information are “no talker,” “first registered person,” and “unknown talker” respectively, then the C characteristics information is found to match the recorded characteristics information; thus, subsequently, at step S17, C direction is re-set as a selected direction, and thereafter the C direction signal is played back in an extracted or emphasized form (step S14). It should be noted here that, if the talker indicated by characteristics information is “no talker,” this means that the direction signal corresponding to that characteristics information contains no human voice, and that, if the talker indicated by characteristics information is “unknown talker,” the direction signal corresponding to that characteristics information does contain a human voice but the talker of that voice has not been identified.

Or if, for the sake of discussion, at step S16, the talkers indicated by the L, C, and R characteristics information are “no talker,” “unknown talker,” and “no talker” respectively, then no characteristics information matches the recorded characteristics information. In this case, however, only the C direction signal corresponding to the C characteristics information contains a human voice, and therefore, of the L, C, and R characteristics information, the C characteristics information can be said to be closest to the recorded characteristics information. Thus, if, at step S16, the talkers indicated by the L, C, and R characteristics information are “no talker,” “unknown talker,” and “no talker” respectively, it is judged that the C characteristics information approximately matches (or is closest to) the recorded characteristics information, and subsequently, at step S17, C direction may be re-set as a selected direction. A similar description applies in a case where the talkers indicated by the L, C, and R characteristics information are “no talker,” “unknown talker,” and “second registered person.”

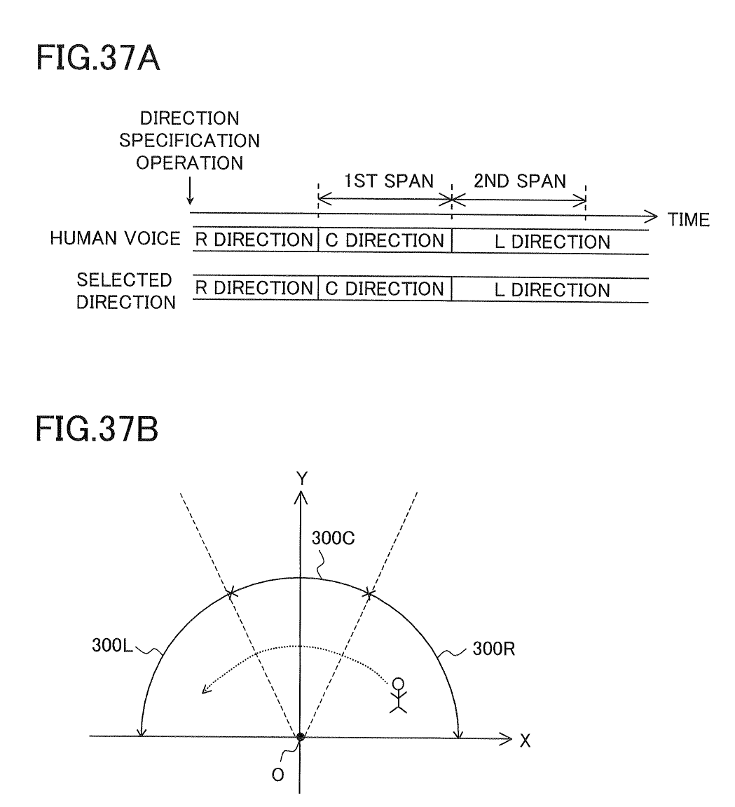

Now, assuming that the change and matching checked for at steps S15 and S16 with respect to characteristics information are those in talker information, a supplementary description will be given of an example of sound source tracking with reference to FIGS. 37A and 37B. In FIGS. 37A and 37B, it is assumed that the talkers at the time of recording of recorded sound signals include a first registered person, and that, during recording, the first registered person moves from area 300R through area 300C to area 300L.

Consider a case where, in the direction specification operation at step S12, R direction is set as a selected direction and the R direction signal at the time of the direction specification operation being performed contains the voice of the first registered person. In this case, the talker information in the recorded characteristics information indicates the first registered person. In a span in which the talker information in the R characteristics information includes the first registered person, R direction remains a selected direction, and the R direction signal is played back in an extracted or emphasized form (step S14). In a first span that follows, the talker information in the R characteristics information ceases to include the first registered person and instead the talker information in the C characteristics information starts to include the first registered person; thus, through the processing at steps S15 through S17, C direction is re-set as a selected direction. In the first span, in which the talker information in the C characteristics information includes the first registered person, C direction is a selected direction, and the C direction signal is played back in an extracted or emphasized form (step S14). In a second span that further follows, the talker information in the C characteristics information ceases to include the first registered person, and instead the talker information in the L characteristics information starts to include the first registered person; thus, through the processing at steps S15 through S17, L direction is re-set as a selected direction. In the second span, in which the talker information in the L characteristics information includes the first registered person, L direction is a selected direction, and the L direction signal is played back in an extracted or emphasized form (step S14).

In this way, in the sound source tracking function, based on the L, C, and R characteristics information in the first span generated from the target sound signals in the first span, the selected direction (selected origination direction) in the first span is determined, and, based on the L, C, and R characteristics information in the second span generated from the target sound signals in the second span, the selected direction (selected origination direction) in the second span is determined. Here, the selected directions in the first and second spans are so set that the origination direction of the signal component of a sound source to be tracked, that is, the origination direction of the signal component of a sound having particular characteristics (for example, a sound of the type “human voice,” or a sound made by the first registered person as a talker) is included in both of the selected directions in the first and second spans.

With the sound source tracking function described above, it is possible to output a playback sound as if tracking a sound having particular characteristics.

While specific operation for the sound source tracking function has been described assuming that the change and matching checked for at steps S15 and S16 with respect to characteristics information is those in sound type information or talker information, it should be understood that what has been specifically described is merely an example.

In the above description of the sound source tracking function, first, direction specification operation is performed to set a selected direction. Instead, in a case where prescribed characteristics information is previously recorded in the sound signal processing device 202, irrespective of direction specification operation, the playback sound signal generator 213 may automatically set a selected direction based on the prescribed characteristics information and on characteristics information. As described above, the user can set prescribed characteristics information via the operation section 205. When the prescribed characteristics information matches the R characteristics information, irrespective of direction specification operation, at step S213, the playback sound signal generator 213 can set R direction as a selected direction and record the prescribed characteristics information as recorded characteristics information (a similar description applies to C and L directions).

For example, it is possible to set, in prescribed characteristics information, sound type information stating that the sound type is “human voice.” In this case, if the C characteristics information indicates that the sound type of the C direction signal is “human voice,” the C characteristics information matches the prescribed characteristics information; thus C direction is set as a selected direction, and the prescribed characteristics information is recorded as recorded characteristics information (step S31). The processing performed thereafter at step S14 and the following steps is as described above.

While the above description deals with cases in which only one direction is set as a selected direction at a time, a plurality of directions may instead be set simultaneously as selected directions. Specifically, if, at step S12, L and C directions are specified, it is possible to set L and C directions each as a selected direction, record the L and C characteristics information at the time of that specification as first and second recorded characteristics information, and play back the direction signal matching each set of recorded characteristics information in an extracted or emphasized form in the manner described above.

### Applied Techniques

Applied techniques usable in the recording/playback device 200 will be enumerated below.

In a case where Signal Processing 1 is applied to a specified direction or selected direction, that is, in a case where the direction signal of a specified direction or selected direction is selectively played back as a playback sound signal, if the direction signal of the specified direction or selected direction has a silent span, its playback in the silent span may be skipped, or may be done at fast speed by use of well-known speech speed conversion. A silent (or mute) span denotes a span in which the signal level of a sound signal of interest is equal to or lower than a predetermined level.

In a case where the recording/playback device 200 is provided with the capabilities of an image shooting device, and in addition where, before recording of a recorded sound signal, a still or moving image has been shot and the image data of the still or moving image has been recorded to the recording medium 201, the still or moving image may be displayed on the display section 204 during playback of the recorded sound signal. During playback of the recorded sound signal, the still or moving image is displayed on the image 350a in FIG. 29A or on the image 370 in FIG. 32, or is displayed alongside the image 350a and/or the image 370.

A playback sound signal generated according to direction specification operation by the user may be recorded to the recording medium 201 separately from a recorded sound signal.

A parameter for the signal processing performed in the sound signal processing device 202 may be varied according to a recording condition of a recorded sound signal. For example, in a case where a recorded sound signal is recorded at a comparatively low bit rate (that is, in a case where a recorded sound signal is compressed at a comparatively high compression factor), the recorded sound signal contains large distortion, and this makes it difficult to perform ideal signal processing as originally intended. Accordingly, in a case where a recorded sound signal is recorded at a comparatively low bit rate, it is preferable to use weaker directivity control or the like. Specifically, for example, while, when a recorded sound signal is recorded at a comparatively high bit rate, Signal Processing 2 described above amplifies the signal level of the L direction signal by a factor of 5, when a recorded sound signal is recorded at a comparatively low bit rate, the factor by which the signal level is amplified may be reduced to 3.

In a case where it is estimated that signal processing 1 to 3 or the sound source tracking function is unlikely to work effectively, the estimation may be presented to the user before playback, and the recording/playback device 200 may ask the user whether or not to use, even then, signal processing 1 to 3 or the sound source tracking function. For example, in a case where a recorded sound signal is recorded at a comparatively low bit rate, it is estimated that, under the influence of large distortion, signal processing 1 to 3 or the sound source tracking function is unlikely to work effectively. The same is true in a case where a recorded sound signal is generated by use of a microphone portion comprising a plurality of directional microphones having different directions of directivity. This is because subjecting a sound signal having directivity obtained from directional microphones to further directivity control in the signal separator 211 in FIG. 22 hardly yields the expected result.

In a case where it is judged that signal processing 1 to 3 or the sound source tracking function does not work effectively and thus it is impossible to obtain a playback sound signal as intended (for example, in a case where directivity control cannot be performed as intended and thus L, C, and R direction signals cannot be generated from recorded sound signals), execution of signal processing 1 to 3 or the sound source tracking function may be stopped, and an indication to that effect may be presented to the user by use of the display section 204 or the like.

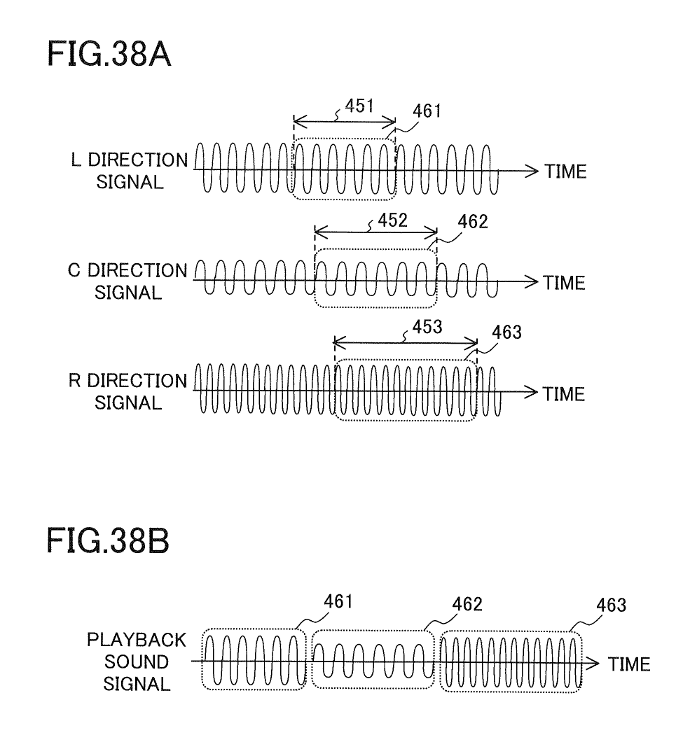

A span in which a sound matching prescribed characteristics information occurs may be extracted from each of the entire span of the L direction signal, the entire span of the C direction signal, and the entire span of the R direction signal so that, when a plurality of spans are extracted, those spans may be played back individually in chronological order. For example, in a case where prescribed characteristics information includes sound type information stating that the sound type is “human voice,” if, as shown in FIG. 38A, the L characteristics information in a span 451 of the L direction signal, the C characteristics information in a span 452 of the C direction signal, and the R characteristics information in a span 453 of the R direction signal each match the prescribed characteristics information, then the L direction signal 461 in the span 451, the C direction signal 462 in the span 452, and the R direction signal 463 in the span 453 are extracted from the L, C, and R direction signals over their entire spans. The extracted signals are then arranged in order of occurrence and are played back individually. Specifically, for example, if the start of the span 451 is earlier than the start of the span 452, and the start of the span 452 is earlier than the start of the span 453, then, as shown in FIG. 38B, the signals 461, 462, and 463 are, in a form joined together in this order, incorporated into a playback sound signal so that the signals 461, 462, and 463 may be played back individually in this order. By use of this method, in a case where the sounds of three people talking approximately at the same time are recorded, it is possible to play back the utterance of each person individually.

### Embodiment 5

Next, a fifth embodiment (Embodiment 5) of the invention will be described. Embodiment 5 again deals with the operation of the recording/playback device 200. While, however, Embodiment 4 assumes that recorded sound signals are sound signals based on the detection signals of the microphones 1L and 1R, in Embodiment 5, the microphones that generate recorded sound signals differ from the microphones 1L and 1R, as will be specifically discussed below.

In Embodiment 5, it is assumed that a first to an n-th unit sound signal are acquired and sound signals including the first to n-th unit sound signals are recorded as recorded sound signals to a recording medium 201 in the following manner.

By collecting the sound from each sound source individually by use of a stereophonic microphone capable of stereophonic sound collection by itself, a first to an n-th unit sound signal separate from one another are directly acquired; or

by use of a first to n-th directional microphone (microphones having directivity), with the high-sensitivity directions of the first to n-th directional microphones aligned with the first to n-th directions corresponding to a first to an n-th sound source, the sound from each sound source is collected individually, and thereby a first to an n-th unit sound signal are acquired directly in a form separate from one another; or

in a case where the locations of a first to an n-th sound source are previously known, by use of a first to an n-th cordless microphone, the first to n-th cordless microphones may be arranged at the locations of the first to n-th sound sources so that an i-th cordless microphone may collect the sound of an i-th sound source (where i=1, 2, . . . , (n−1), n). In this way, by the first to n-th cordless microphones, a first to an n-th unit sound signal corresponding to the first to n-th sound sources are directly acquired in a form separate from one another.

The above-mentioned stereophonic microphones, or first to n-th directional microphones, or first to n-th cordless microphones may be provided in the recording/playback device 200 so that the recording/playback device 200 itself may collect the first to n-th unit sound signals; or the first to n-th unit sound signals may be acquired by a recording device other than the recording/playback device 200 so that sound signals including the first to n-th unit sound signals may be recorded to the recording medium 201.

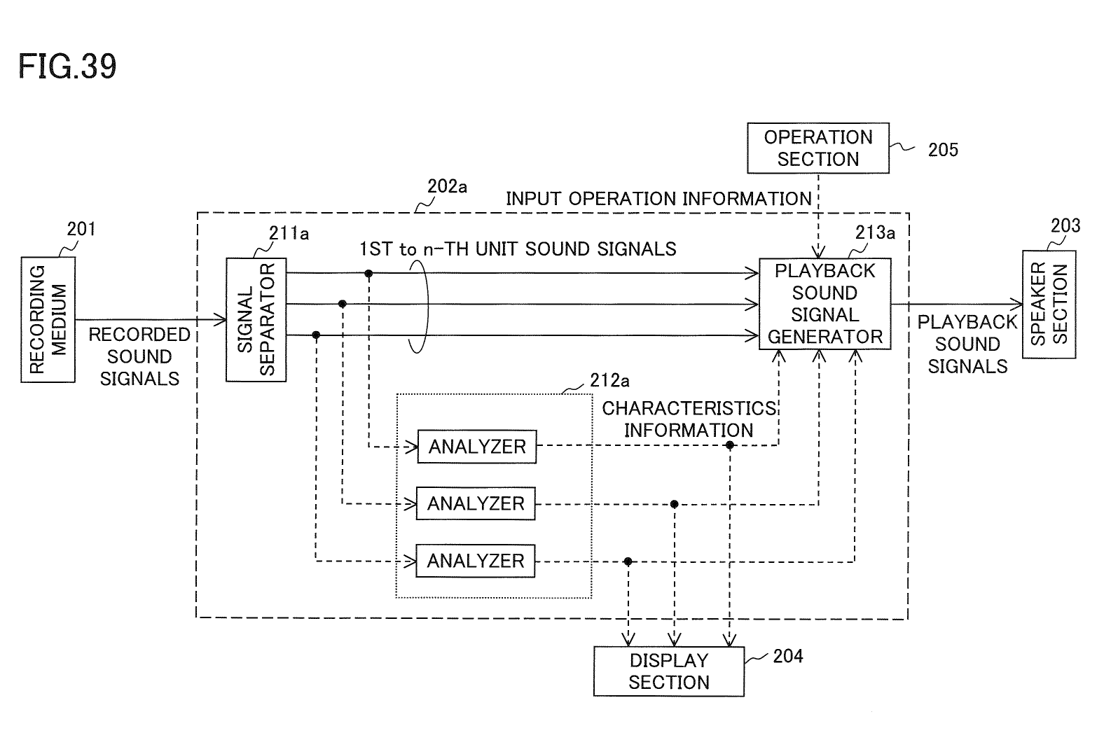

The sound signal processing device 202 provided in the recording/playback device 200 according to Embodiment 5 is especially called the sound signal processing device 202a. FIG. 39 is a part block diagram of the recording/playback device 200 including an internal block diagram of the sound signal processing device 202a. The sound signal processing device 202a is provided with a signal separator 211a, a sound characteristics analyzer 212a, and a playback sound signal generator (signal processor) 213a.

Under the assumptions made in Embodiment 5, the recorded sound signals acquired as described above are fed from the recording medium 201 to the signal separator 211a. The signal separator 211a separates and extracts from the recorded sound signals the first to n-th unit sound signals, and outputs the first to n-th unit sound signals to the sound characteristics analyzer 212a and to the playback sound signal generator 213a. Since the recorded sound signals have been generated by use of directional microphones or the like, the separation and extraction here can be done easily.

The sound characteristics analyzer 212a analyzes each unit sound signal, and generates, for each unit sound signal, characteristics information representing the characteristics of the sound. Specifically, based on the i-th unit sound signal, the sound characteristics analyzer 212a analyzes the characteristics of the sound the i-th unit sound signal conveys, and generates i-th characteristics information representing the characteristics of that sound (where i is an integer). The i-th characteristics information based on the i-th unit sound signal is similar to the L characteristics information based on the L direction signal described in Embodiment 4. Accordingly, the sound characteristics analyzer 212a can incorporate into the i-th characteristics information one or more of sound volume information, sound type information, human voice presence/absence information, and talker information. In the i-th characteristics information, sound volume information represents the sound volume of the sound conveyed by the i-th unit sound signal; sound type information represents the type of the sound conveyed by the i-th unit sound signal; human voice presence/absence information represents whether or not the sound conveyed by the i-th unit sound signal contains a human voice; and talker information represents the talker of the human voice contained in the i-th unit sound signal. How the sound characteristics analyzer 212a analyzes sound signals and generates characteristics information is the same as how the sound characteristics analyzer 212 does.

The characteristics information generated for each unit sound signal in the sound characteristics analyzer 212a is displayed on the display section 204. The playback sound signal generator 213a generates playback sound signals from the first to n-th unit sound signals. These playback sound signals are fed to the speaker section 203, which comprises one speaker or a plurality of speakers, so as to be played back as sounds.

The user can perform, on the operation section 205, sound source specification operation to specify one or more but n or less of the first to n-th unit sound signals (in other words, the first to n-th sound sources). It is here assumed that input operation on the operation section 205 at least includes sound source specification operation. A unit sound signal and a sound source specified by sound source specification operation are called a specified unit signal and a specified sound source respectively.

As described previously, n is any integer of 2 or more; in this embodiment, it is assumed that n=3.

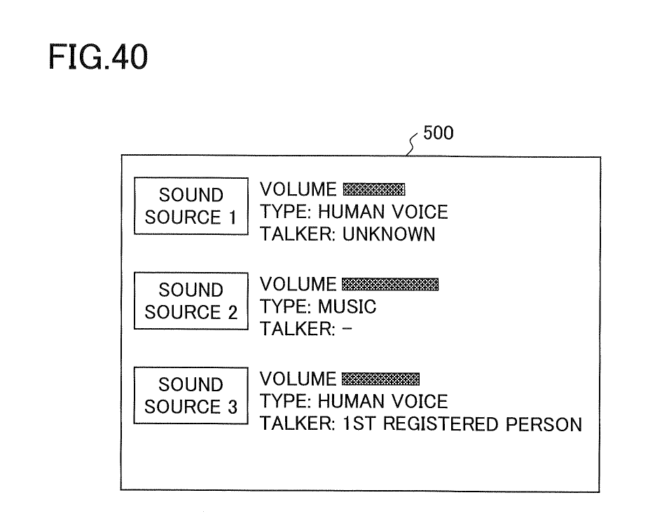

The display section 204 can display the first to third characteristics information individually, on a one-at-a-time basis, and can also display it all at once. As an example of the image that can be displayed on the display section 204, FIG. 40 shows an image 500. In the image 500, there is indicated sound volume information, sound type information, and talker information with respect to the first to third sound sources (that is, with respect to the first to third unit sound signals). The human voice presence/absence information with respect to the first to third sound sources (that is, with respect to the first to third unit sound signals) may be displayed on the display section 204 instead of, or along with, the image 500. In FIG. 40, the sound type of each sound source is indicated in characters; instead, as in Embodiment 4, icons representing sound types may be displayed. A similar description applies to talker information etc. As in Embodiment 4, the sound signal processing device 202a is capable of both real-time display and prior display of characteristics information. So long as the user can be notified of characteristics information for each unit sound signal, how to notify of characteristics information may be modified in may ways.

The user can perform sound source specification operation by touch-panel operation or by operation of a four-way key (unillustrated) provided in the operation section 205. The playback sound signal generator 213a can output the recorded sound signals intact as playback sound signals (that is, it can output, as playback sound signals, signals obtained by simply compositing the first to third unit sound signals); instead, the playback sound signal generator 213a can apply signal processing according to input operation by the user to the recorded sound signals composed of the first to third unit sound signals, thereby to generate playback sound signals. As the just-mentioned signal processing, the playback sound signal generator 213a can execute one of Signal Processing 1 to 3 described with regard to Embodiment 4.

Signal Processing 1: Signal Processing 1 by the playback sound signal generator 213a will now be described. In Signal Processing 1, a playback sound signal is generated by extracting a specified unit signal from recorded sound signals composed of the first to third unit sound signals. Signal Processing 1 functions effectively when the number of specified unit signals is (n−1) or less (that is, 1 or 2).

For example, in a case where the first unit sound signal alone has been specified by sound source specification operation, the first unit sound signal is taken as a playback sound signal. A similar description applies in cases where a second or third unit sound signal alone is specified. For another example, in a case where the first and second unit sound signals have been specified by sound source specification operation, a composite signal of the first and second unit sound signals is generated as a playback sound signal.

By use of Signal Processing 1, the user can, while consulting what is displayed as characteristics information, listen to the sound from the desired sound source alone.

Signal Processing 2: Signal Processing 2 by the playback sound signal generator 213a will now be described. In Signal Processing 2, a playback sound signal is generated by applying processing for emphasizing or attenuating a specified unit signal to recorded sound signals composed of the first to third unit sound signals. Signal Processing 2 functions effectively when the number of specified unit signals is n or less (that is, 1, 2, or 3).

For example, the user can specify the first unit sound signal as a specified unit signal and then specify, by input operation, amplification or attenuation of the first unit sound signal. Here, the user can freely specify, by input operation, also the degree of amplification or attenuation. Amplifying a sound signal is synonymous with emphasizing it. After receiving input operation specifying amplification or attenuation of the first unit sound signal, the playback sound signal generator 213a generates as a playback sound signal a composite signal of the second and third unit sound signals fed from the signal separator 211a and the amplified or attenuated first unit sound signal. While the description has dealt with how a playback sound signal is generated in a case where the first unit sound signal is specified as a specified unit signal, a similar description applies in cases where the second or third unit sound signal is specified as a specified unit signal.

The user can specify two or three of the first to third unit sound signals as specified unit signals, and specify, by input operation, for each of the specified unit signals, amplification or attenuation of that specified unit signal. For example, when input operation specifying amplification of the first unit sound signal and attenuation of the second unit sound signal is performed on the operation section 205, after the input operation, the playback sound signal generator 213a generates as a playback sound signal a composite signal of the third unit sound signal fed from the signal separator 211a, the amplified first unit sound signal, and the attenuated second unit sound signal.

By use of Signal Processing 2, the user can, while consulting what is displayed as characteristics information, listen to the recorded sounds with the sound from the desired sound source emphasized or attenuated.

Signal Processing 3: Signal Processing 3 by the playback sound signal generator 213a will now be described. In Signal Processing 3, a playback sound signal is generated by mixing the unit sound signals in a desired mix ratio.

Signal Processing 3 can be said to be equivalent to Signal Processing 2 as performed when the number of specified unit signals is three. The user can, by input operation, for each specified unit signal, specify whether to amplify or attenuate that specified unit signal and the degree of amplification or attenuation of the specified unit signal. According to what is specified, the playback sound signal generator 213a generates a playback sound signal by compositing the individually amplified or attenuated first to third unit sound signals. Depending on the contents of input operation, however, no amplification or attenuation may be performed on one or two of the first to third unit sound signals.

The user may want to listen to the sound signal from a particular sound source (for example, a sound signal related to a first registered person, or a sound signal having the highest or lowest sound volume) in an extracted or emphasized form, or may want to listen to playback sound signals in which the sound volumes from all sound sources are equal. By use of Signal Processing 1 to 3, it is possible to cope with all those requirements.

In a case where prescribed characteristics information is previously recorded in the sound signal processing device 202a, the playback sound signal generator 213a may, irrespective of input operation, automatically select a specified unit signal based on the prescribed characteristics information and on characteristics information, and perform Signal Processing 1 or 2. In the prescribed characteristics information, there is defined at least one of sound volume information, sound type information, human voice presence/absence information, and talker information. The playback sound signal generator 213a selects, when the prescribed characteristics information agrees with the i-th characteristics information, the i-th unit sound signal as a specified unit signal (where i is 1, 2, or 3).

The user can previously set prescribed characteristics information via the operation section 205, and can previously set what signal processing to perform in the playback sound signal generator 213a with respect to a specified unit signal selected according to the prescribed characteristics information.

For example, it is possible to define, in prescribed characteristics information, sound type information stating that the sound type is “human voice.” In this case, when the first characteristics information indicates that the sound type of the first unit sound signal is “human voice,” the prescribed characteristics information agrees with the first characteristics information; thus, the first unit sound signal is selected as a specified unit signal, and Signal Processing 1 is performed. Specifically, the first unit sound signal is taken as a playback sound signal. Or, the first unit sound signal is selected as a specified unit signal, and Signal Processing 2 is performed. Specifically, for example, a composite signal of the second and third unit sound signals fed from the signal separator 211a and the amplified or attenuated first unit sound signal is generated as a playback sound signal. The degree of amplification or attenuation can also be previously set by the user. A similar description applies in cases where the prescribed characteristics information agrees with second or third characteristics information.

In addition to the techniques described above with regard to this embodiment, any of the techniques described with regard to Embodiment 4 may be applied to the sound signal processing device 202a. In such cases, when the first to third sound sources are the sound sources 311, 312, and 313, respectively, in FIG. 25, the L, C, and R directions in Embodiment 4 are taken as corresponding to the directions of the first, second, and third sound sources, and then a technique described with regard to Embodiment 4 is applied to the sound signal processing device 202a. Specifically, for example, when the first to third sound sources are the sound sources 311 to 313 respectively,

L, C, and R directions in Embodiment 4 are read as the directions of the first, second, and third sound sources, respectively, in Embodiment 5;

moreover, the L, C, and R direction signals in Embodiment 4 are read as the first, second, and third unit sound signals, respectively, in Embodiment 5;

moreover, the L, C, and R characteristics information in Embodiment 4 are read as the first, second, and third characteristics information, respectively, in Embodiment 5;

moreover, direction specification operation in Embodiment 4 is read as sound source specification operation in Embodiment 5;

moreover, a specified direction in Embodiment 4 is read as a specified unit signal or a specified sound source in Embodiment 5, and then a technique described with regard to Embodiment 4 is applied to the sound signal processing device 202a (thus, mutatis mutandis, any feature described with regard to Embodiment 4 may be applied, unless inconsistent, to the sound signal processing device 202a).

### VARIATIONS, MODIFICATIONS, ETC

The specific values given in the description above are merely examples, which, needless to say, may be modified to any other values. In connection with the embodiments described above, modified examples or supplementary explanations applicable to them will be given below in Notes 1 and 2. Unless inconsistent, any part of the contents of these notes may be combined with any other.

Note 1: While, for the sake of simplicity and convenience of description, the description of the embodiments assumes that a plurality of sound sources are located at discrete positions on a two-dimensional XY coordinate plane, a similar description applies in a case where a plurality of sound sources are located at discrete positions in a three-dimensional space.

Note 2: Part of all of the functions realized by a sound signal processing device (10, 202, etc.) may be realized with hardware, software, or a combination of hardware and software. When a sound signal processing device (10, 202, etc.) is built with software, a block diagram showing a part realized with software serves as a functional block diagram of that part. Part or all of the functions realized by a sound signal processing device (10, 202, etc.) may be prepared as a software program so that this software program may be executed on a program execution device (for example, a computer) to realize all or part of those functions.

What is claimed is:

1. A sound signal processing device comprising:
a signal outputter which outputs a target sound signal obtained by collecting sounds from a plurality of sound sources; and
a sound volume controller which adjusts sound volumes of the individual sound sources in the target sound signal according to directions or locations of the sound sources and according to types of the sound sources.

2. The sound signal processing device according to claim 1, wherein
the plurality of sound sources comprise first to n-th sound sources (where n is an integer of 2 or more), and the target sound signal includes first to n-th unit sound signals corresponding to the first to n-th sound sources and separated from one another, and
the first to n-th unit sound signals are extracted from detection signals of a plurality of microphones arranged at different positions, or are obtained by collecting the sounds from the first to n-th sound sources individually.

3. The sound signal processing device according to claim 2, wherein
the first to n-th unit sound signals are extracted from the detection signals of the plurality of microphones,
the signal outputter generates, from the detection signals of the plurality of microphones, and outputs, as the first to n-th unit sound signals, n sound signals having directivity in which signal components of sounds originating from first to n-th directions are emphasized, and
the sound volume controller adjusts the sound volumes of the individual sound sources in the target sound signal according to the first to n-th directions representing the directions of the first to n-th sound sources and according to the types of the sound sources.

4. The sound signal processing device according to claim 2, wherein
the first to n-th unit sound signals are obtained by collecting the sounds from the first to n-th sound sources individually, and
the directions or locations of the sound sources are determined from directivity or arrangement positions of individual microphones for collecting the sounds from the first to n-th sound sources individually.

5. The sound signal processing device according to claim 2, further comprising:
a sound type detector which discriminates types of the sound sources of the individual unit sound signals based on the unit sound signals; and
a sound volume detector which detects signal levels of the individual unit sound signals, wherein
the sound volume controller adjusts the sound volumes of the individual sound sources in the target sound signal by adjusting the signal levels of the unit sound signals individually based on the directions or locations of the sound sources, based on the types of the sound sources discriminated by the sound type detector, and based on the signal levels detected by the sound volume detector.

6. The sound signal processing device according to claim 5, wherein
in the sound volume controller, a band of each unit sound signal is divided into a plurality of sub-bands, and the signal level of each unit sound signal is adjusted in each sub-band individually.

7. An appliance comprising the sound signal processing device according to claim 1, wherein the appliance records or plays back, as an output sound signal, the target sound signal as having undergone the volume adjustment by the sound volume controller of the sound signal processing device, or a sound signal based on the target sound signal as having undergone the volume adjustment.

8. The appliance according to claim 7, wherein
the appliance includes a recording device which records the output sound signal, a playback device which plays back the output sound signal, or an image shooting device which records or plays back the output sound signal along with an image signal of a shot image.

9. A playback device which plays back, as sounds, an output sound signal based on an input sound signal obtained by collecting sounds from a plurality of sound sources, the playback device comprising:
a sound characteristics analyzer which analyzes the input sound signal for each sound origination direction to generate characteristics information representing sound characteristics for each sound origination direction;
a notifier which indicates the characteristics information to outside the playback device;
an operation receiver which receives, from outside, input operation including direction specification operation for specifying one or more of first to m-th different origination directions (where m is an integer of 2 or more) present as sound origination directions; and
a signal processor which generates the output sound signal by applying signal processing according to the input operation to the input sound signal.

10. The playback device according to claim 9, wherein
the signal processor
generates the output sound signal by extracting, from the input sound signal, signal components from the one or more origination directions specified by the input operation, or
generates the output sound signal by applying, to the input sound signal, signal processing for emphasizing or attenuating signal components from the one or more origination directions specified by the input operation, or
generates the output sound signal by mixing, according to the input operation, signal components from the individual origination directions included in the input sound signal.

11. The playback device according to claim 9, wherein
the characteristics information for each sound origination direction includes at least one of
sound volume information representing a sound volume of a sound,
sound type information representing a sound type of a sound,
human voice presence/absence information representing whether or not a sound contains a human voice, and
talker information representing a talker when a sound is a human voice.

12. A playback device which plays back, as sounds, an output sound signal based on an input sound signal obtained by collecting sounds from a plurality of sound sources, the playback device comprising:
a sound characteristics analyzer which analyzes the input sound signal for each sound origination direction to generate characteristics information representing sound characteristics for each sound origination direction; and
a signal processor which selects one or more of first to m-th different origination directions (where m is an integer of 2 or more) present as sound origination directions and which generates the output sound signal by applying, to the input sound signal, signal processing for extracting, from the input sound signal, signal components from the selected one or more origination directions or signal processing for emphasizing signal components from the selected one or more origination directions, wherein
the signal processor switches the selected one or more origination directions according to the characteristics information.

13. The playback device according to claim 12, wherein
an entire span of the input sound signal includes first and second different spans, and
the signal processor determines the selected one or more origination directions based on the characteristics information of the input sound signal such that an origination direction of a signal component of a sound having particular characteristics is included in the selected one or more origination directions in both the first and second spans.

14. The playback device according to claim 12, wherein
the characteristics information for each sound origination direction includes at least one of
sound volume information representing a sound volume of a sound,
sound type information representing a sound type of a sound,
human voice presence/absence information representing whether or not a sound contains a human voice, and
talker information representing a talker when a sound is a human voice.

15. A playback device which generates an output sound signal from an input sound signal including a plurality of unit sound signals obtained by collecting sounds from a plurality of sound sources individually and which plays back the output sound signal as sounds, the playback device comprising:
a sound characteristics analyzer which analyzes the unit sound signals to generate, for each unit sound signal, characteristics information representing characteristics of a sound;
a notifier which indicates the characteristics information to outside the playback device;
an operation receiver which receives, from outside, input operation including specification operation for specifying one or more of the plurality of unit sound signals (where m is an integer of 2 or more); and
a signal processor which generates the output sound signal by applying signal processing according to the input operation to the input sound signal.

16. The playback device according to claim 15, wherein
the signal processor
generates the output sound signal by extracting, from the input sound signal, the one or more unit sound signals specified by the input operation, or
generates the output sound signal by applying, to the input sound signal, signal processing for emphasizing or attenuating the one or more unit sound signals specified by the input operation, or
generates the output sound signal by mixing, according to the input operation, signal components from the individual unit sound signals included in the input sound signal.

17. The playback device according to claim 15, wherein
the characteristics information for each unit sound signal includes at least one of
sound volume information representing a sound volume of a sound,
sound type information representing a sound type of a sound,
human voice presence/absence information representing whether or not a sound contains a human voice, and
talker information representing a talker when a sound is a human voice.
